(19) United States
(12) Patent Application Publication
(10) Pub. No.: US 2016/0299678 A1
(43) Pub. Date: Oct. 13, 2016

(54) SYSTEM AND METHOD FOR INFORMATION PRESENTATION AND VISUALIZATION

(71) Applicant: Innoruptor LLC, West Chester, PA (US)

(72) Inventor: Michael Raber, West Chester, PA (US)

(21) Appl. No.: 15/097,327

(22) Filed: Apr. 13, 2016

Related U.S. Application Data
(60) Provisional application No. 62/146,630, filed on Apr. 13, 2015.
(60) Provisional application No. 62/204,123, filed on Aug. 12, 2015.

(51) Int. Cl. G06F 3/0484; G06T 11/20; G06F 3/0482

(52) U.S. Cl. CPC G06F 3/04847; G06F 3/0482; G06T 11/206; G06T 2200/24

(57) ABSTRACT

A system and method for presentation and visualization of involves storing predefined data element types. Each data element type is configured to receive user input, and to interact with any associated data elements according to predefined instructions stored within the system. The method includes displaying via a display device a graphical user interface displaying a workspace, and permitting a user to: create a plurality of data elements of predefined data element types; provide user input in association with the data element; and arrange created data elements within the workspace to selectively indicate association among multiple data elements by selectively arranging data elements to be associated in a predefined associative spatial relationship defined by the presentation system. The method further includes: identifying associated data elements; exchanging information associated with the associated data elements according to predefined instructions; and displaying a visualization of information as a function of the exchanged information.

### CROSS-REFERENCE TO RELATED APPLICATION

This application claims the benefit of priority, under 35 U.S.C. §119(e), of U.S. Provisional Patent Application No. 62/146,630 filed Apr. 13, 2015, and 62/204,123 filed Aug. 12, 2015, the entire disclosures of both of which are hereby incorporated herein by reference.

### FIELD OF THE INVENTION

The present invention relates generally to computerized information processing systems, and more particularly to a system and method for information presentation and visualization.

### DISCUSSION OF RELATED ART

Computerized information processing systems are ubiquitous, and are used in the home and in the workplace for a variety of purposes. Software applications designed to run on such systems allow users to perform a wide variety of functions tasks. In some cases, software applications are designed to display or present information.

A grid metaphor is commonly used, e.g., in a spreadsheet, dashboard or website, to display information. Computing environments including such a grid layout are typically relatively “dumb,” in that, even if there are sophisticated tools within the environment, the data elements are generic, and a high degree of user effort is required to configure the functioning of each box and/or any relationships among multiple boxes. In such cases, the grid metaphor functions merely to provide a physical layout or organization to information. Such configuration to associate and/or develop relations among the information itself is time consuming and highly susceptible to errors.

What is needed is a “smart” computing environment in which the data elements are more sophisticated, and in which configurations and/or relationships among data elements are predefined and/or administered automatedly, so as to reduce the burden on any user, and to reduce the occurrence of errors.

### SUMMARY

The present invention provides a system and method for information presentation and visualization. The method comprises storing a data store of predefined data element types. Each data element type is configured to receive user input, and to interact with any associated data elements according to predefined instructions stored within the system. The method includes displaying via a display device a graphical user interface displaying a workspace, and permitting a user to: create a plurality of data elements, each data element having one of the predefined data element types; provide user input in association with the data element; and arrange created data elements within the workspace to selectively indicate association among multiple data elements by selectively arranging data elements to be associated in a predefined associative spatial relationship defined by the presentation system. The method further includes: identifying associated data elements; exchanging information associated with at least one of the associated data elements, in accordance with the predefined instructions; and displaying, via the graphical user interface a visualization of information as a function of the exchanged information.

### BRIEF DESCRIPTION OF THE FIGURES

An understanding of the following description will be facilitated by reference to the attached drawings, in which:

FIG. 1 is a system diagram showing an exemplary network computing environment in which the present invention may be employed;

FIG. 2 is a schematic diagram of an exemplary special-purpose computing device in accordance with an exemplary embodiment of the present invention;

FIG. 3 is a block diagram illustrating relationships among logical components of the exemplary computing device of FIG. 2;

FIG. 4 is a flow diagram illustrating an exemplary method for information presentation and visualization;

FIG. 5 is an image of an exemplary computing device of FIG. 1, shown displaying a workspace in accordance with an exemplary embodiment of the present invention;

FIG. 6 is an image of an exemplary user interface window showing information presentation and visualization in accordance with an exemplary embodiment of the present invention;

FIG. 7 is a block diagram showing a Document/Sheet/Data Element hierarchy;

FIG. 8 shows an exemplary document class definition;

FIG. 9 shows an exemplary sheet class definition;

FIG. 10 shows an exemplary data element class definition;

FIGS. 11-14 are diagrammatic representations illustrating various of data element relationships;

FIG. 15 is a flow diagram illustrating an exemplary method for finding associated data elements;

FIGS. 16-18 show exemplary user interface windows for creating and associating a plurality of photograph-type data elements;

FIG. 19 shows an exemplary presentation of associated photograph-type data elements;

FIG. 20 shows an exemplary visualization of the associated data elements of FIG. 19;

FIGS. 21-28 show exemplary user interface windows for creating and associating text-type data elements;

FIG. 29 shows an exemplary visualization of the associated data elements of FIG. 28;

FIGS. 30 and 31 show exemplary visualizations of associated number-type and chart-type data elements;

FIG. 32 shows an exemplary visualization of associated task-type data elements;

FIGS. 33-38 show exemplary user interface windows for creating and associating task-type data elements;

FIG. 39 shows an exemplary visualization of associated photograph-type, address-type and map-type data elements; and

FIGS. 40-44 show exemplary user interface windows for creating and associating the data elements of FIG. 39.

### DETAILED DESCRIPTION

The present invention relates to a system and method for presentation and/or visualization of information. More specifically, the present invention provides a graphical user interface with user-manipulable elements that cause the system to create and/or display information as a function of a user-created physical arrangement of predefined, but user-configurable, data elements.

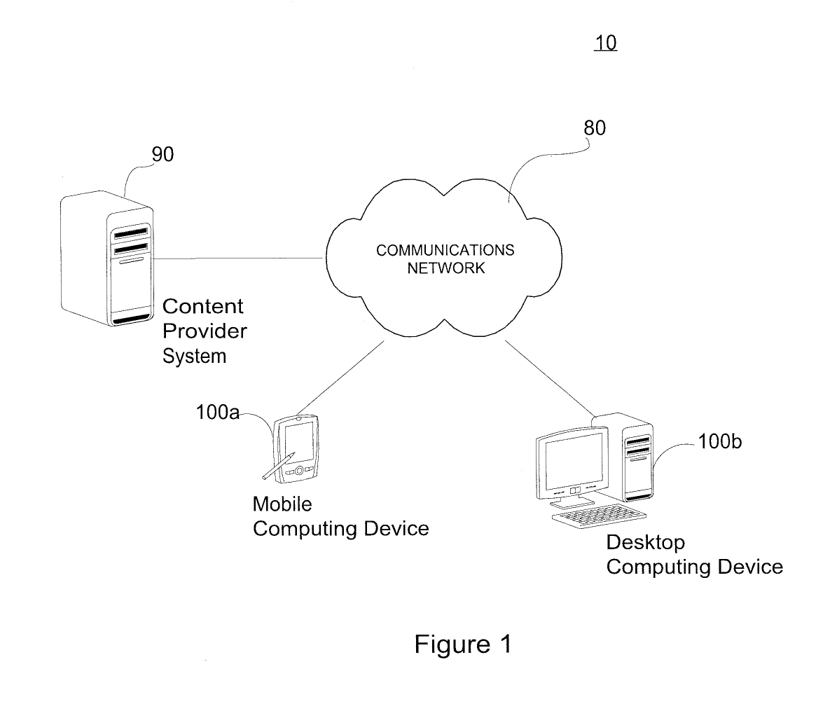

An exemplary embodiment of the present invention is discussed below for illustrative purposes. FIG. 1 is a system diagram showing an exemplary network computing environment in which the present invention may be employed.

The present invention may be understood with reference to the exemplary simplified network environment 10 of FIG. 1. As shown in FIG. 1, the exemplary network environment 10 includes a conventional content provider data system 90, which may be a web server. As further illustrated by FIG. 1, the exemplary network computing environment 10 further includes a computing devices, such as mobile computing device 100a and desktop computing device 100b. Any suitable computing devices may be used for the purposes described herein. By way of example, the mobile computing device may be a smartphone, a tablet computer, or the like that includes conventional hardware and software and is able to communicate with the content provider data system for the purposes described herein. Similarly, the desktop computing device 100b may be a personal computer (PC) or the like that includes conventional hardware and software and is able to communicate with the content provider data system for the purposes described herein.

In this exemplary embodiment, the content provider system 90 is operatively connected to the computing devices 100a, 100b via a communications network 80, such as the Internet and/or a Virtual Private Network (VPN) connection. Hardware and software for enabling communication of data by such devices via such communications networks are well known in the art and beyond the scope of the present invention, and thus are not discussed in detail herein.

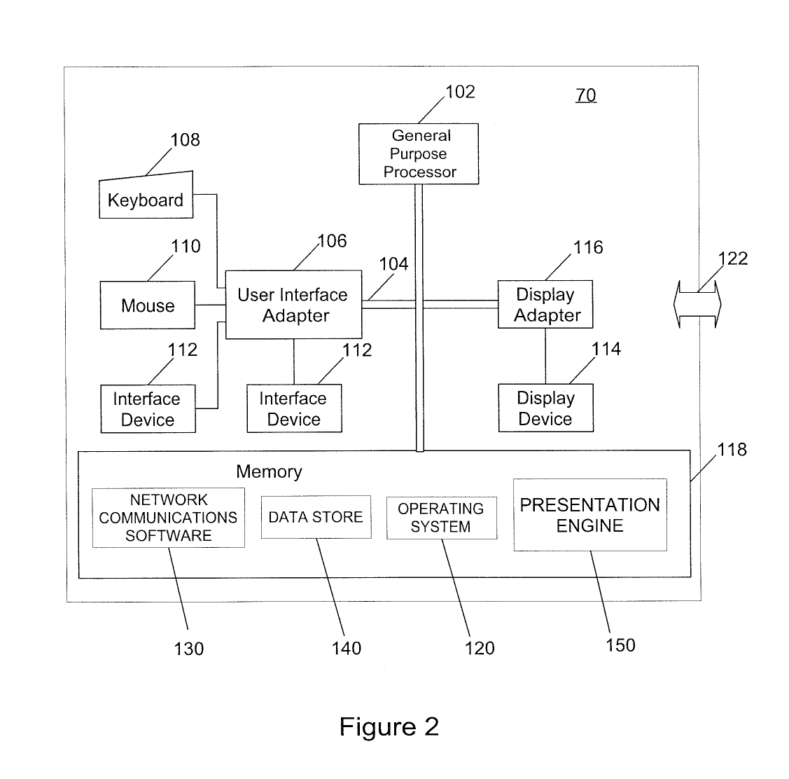

FIG. 2 is a block diagram showing an exemplary presentation system 100 (either computing device 100a or 100b) in accordance with an exemplary embodiment of the present invention. The presentation system 100 is a special-purpose computer system that includes conventional server hardware storing and executing both conventional software enabling operation of a general purposes computing system, such as operating system software 120 and network communications software 130, and specially-configured computer software for configuring the general purpose hardware as a special-purpose computer system including a presentation engine 150 for carrying out at least one method in accordance with the present invention. By way of example, the communications software 130 may include conventional web browser software, and the operating system software 120 may include iOS, Android, Windows, Linux software.

Accordingly, the exemplary presentation system 100 of FIG. 2 includes a general purpose processor, such as a microprocessor (CPU), 102 and a bus 104 employed to connect and enable communication between the processor 102 and the components of the presentation system in accordance with known techniques. The exemplary presentation system 100 includes a user interface adapter 106, which connects the processor 102 via the bus 104 to one or more interface devices, such as a keyboard 108, mouse 110, and/or other interface devices 112, which can be any user interface device, such as a touch sensitive screen, digitized entry pad, etc. The bus 104 also connects a display device 114, such as an LCD screen or monitor, to the processor 102 via a display adapter 116. The bus 104 also connects the processor 102 to memory 118, which can include a hard drive, diskette drive, tape drive, etc.

The presentation system 100 may communicate with other computers or networks of computers, for example via a communications channel, network card or modem 122. The presentation system 100 may be associated with such other computers in a local area network (LAN) or a wide area network (WAN), and may operate as a server in a client/server arrangement with another computer, etc. Such configurations, as well as the appropriate communications hardware and software, are known in the art.

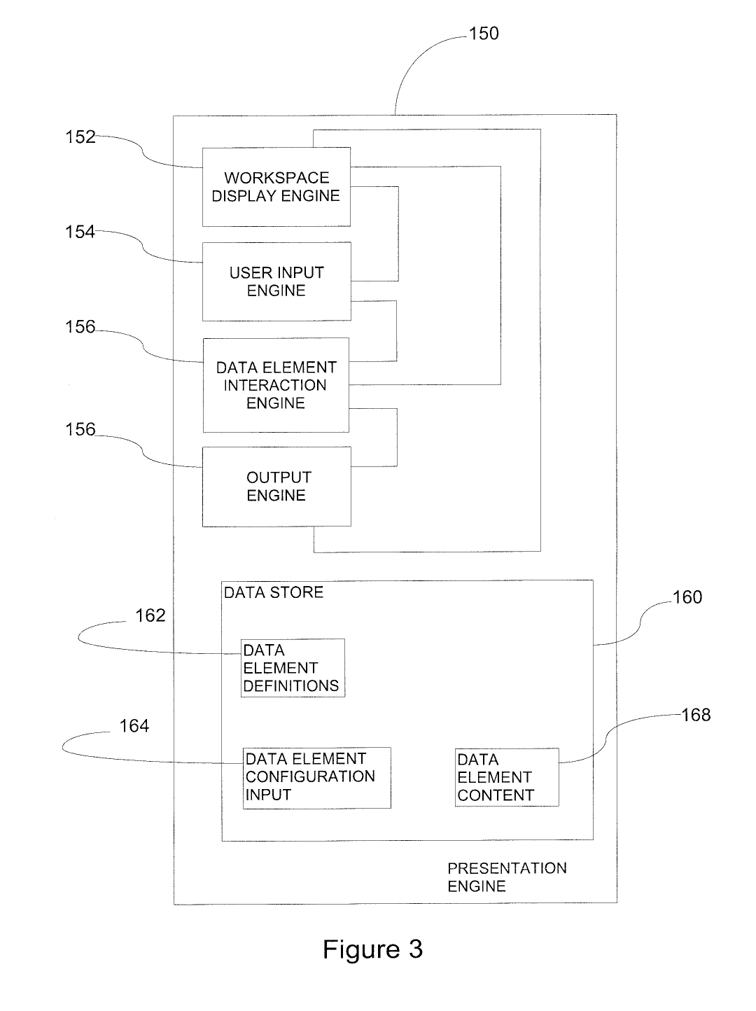

The presentation system 100 is specially-configured in accordance with the present invention. Accordingly, as shown in FIG. 2, the presentation system 100 includes computer-readable, processor-executable instructions stored in the memory for carrying out the methods described herein. Further, the memory stores certain data, e.g. in databases or other data stores shown logically in FIGS. 2 and 3 for illustrative purposes, without regard to any particular embodiment in one or more hardware or software components. For example, FIG. 2 shows schematically storage in the memory 218 of presentation engine software 150. Optionally, other software and/or data may be stored in a corresponding data store 140 of the memory 118.

FIG. 3 is a block diagram illustrating selected logical components of the exemplary presentation engine 150 of FIGS. 1 and 2. As will be noted from FIG. 3, the presentation engine 150 principally includes a workspace engine 152, a user input engine 154, a data element interaction engine 156 and an output engine 158. These engines may be implemented primarily by software including microprocessor-executable instructions stored in the memory 118 of the presentation system 100.

Further, the presentation engine 150 may include a data store 160 storing data element definitions 162, data element configuration input 164 provided by a user, and data element content 168 retrieved via the communications network from the content provider system 90.

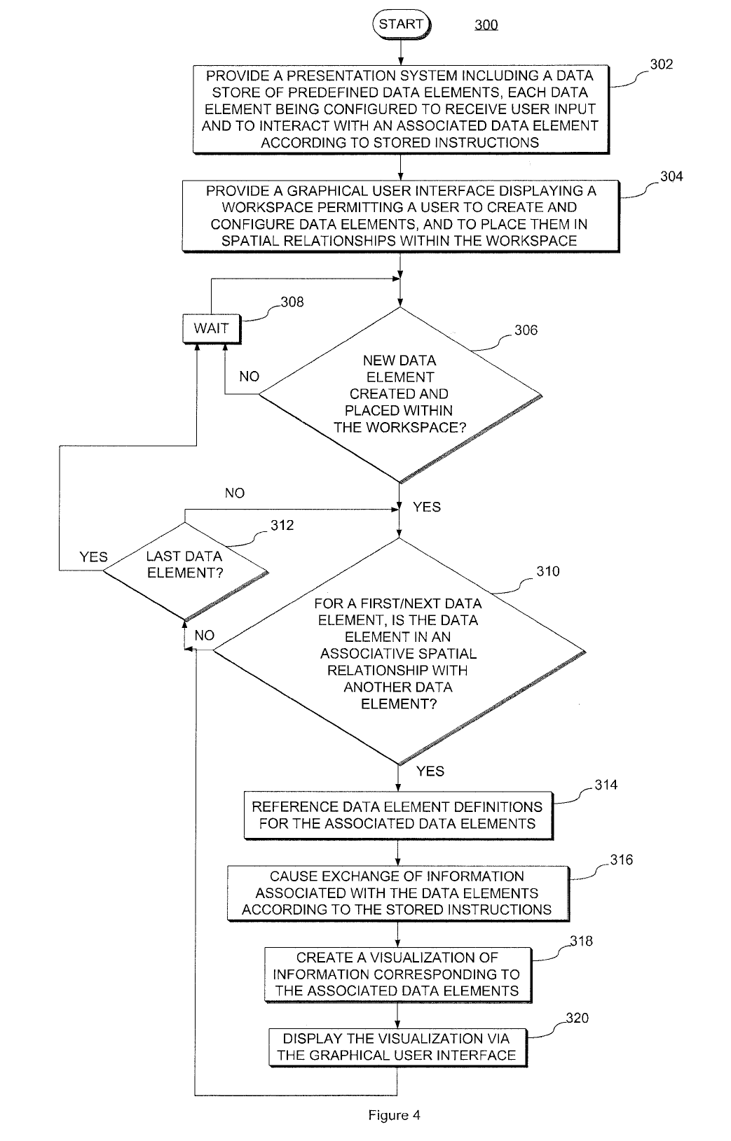

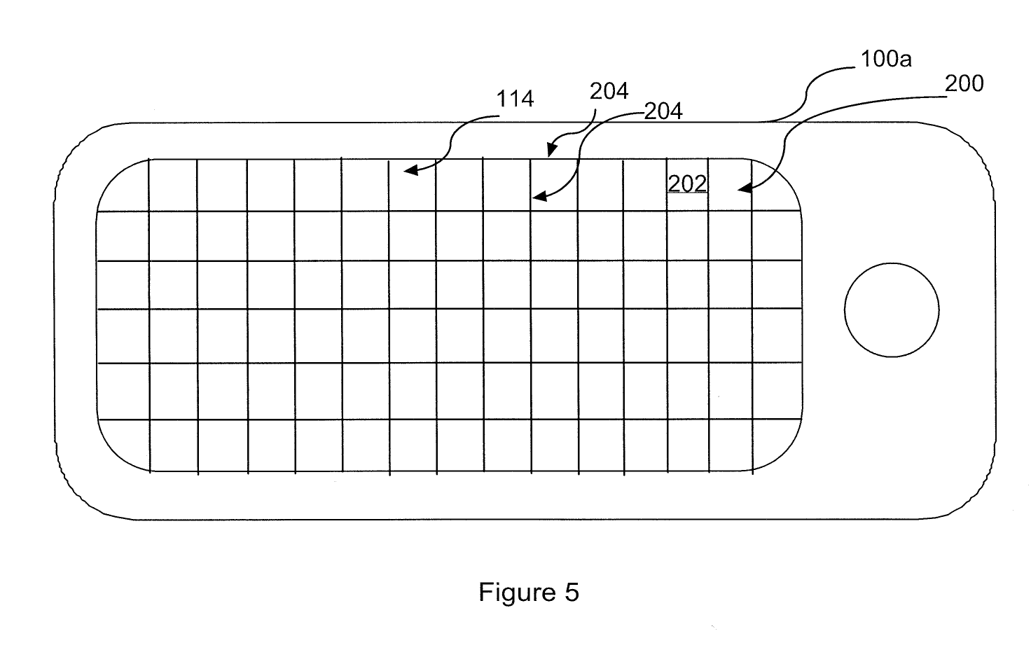

FIG. 4 is a flow diagram 300 illustrating an exemplary method for information presentation and visualization. More specifically, the flow diagram 300 illustrates an exemplary method for providing a graphical user interface with user-manipulable data elements that cause the system to create and/or display information as a function of a user-created spatial arrangement of predefined, but user-configurable, data elements. Referring now to FIG. 4, the exemplary method begins with providing of a presentation system (see FIG. 5) including a data store of predefined data elements, as shown at 300 and 302. See FIG. 5, discussed below. In accordance with the present invention each data element is preconfigured, according to each data element type, to receive user input. For example, a text-type data element is configured to receive text and certain other parameters, and an image-type data element is configured to receive a an image file and other parameters, and a number-type data element is configured to receive numbers, formulas, and other parameters. Such user-provided input may be received by the user input engine 154, and be stored as data element configuration input 164 stored in data store 160, as shown in FIG. 3. Further, each data element is configured to interact with any associated data elements according to stored instructions. The stored instructions are associated with the data element and are stored in a memory of the presentation system in as part of data element definitions. Examples are provided below. By way of brief example, a certain number-type data element may be configured with user input providing for summing of numbers in associated number-type data elements.

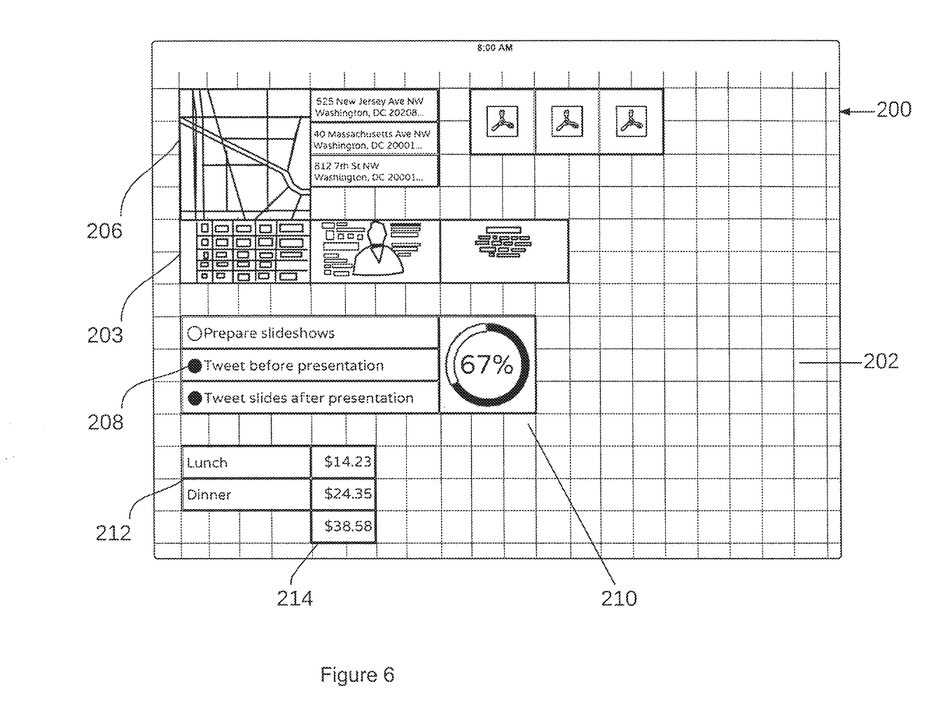

Further, the method involves providing a graphical user interface displaying a workspace permitting a user to create and configure data elements, and to arrange them e.g., to place them in various spatial relationships) within the workspace e.g., by creating a document within the workspace, as shown at 304. Referring to FIG. 6, it will be appreciated that in this example the data elements of 208 and 210 are spatially associated with one another, and the data elements of 212 and 214 are spatially associated with one another, but that the data elements of 208 and 210 are not spatially associated with the data elements of 212 and 214 for the purposes of the present invention, as discussed in greater detail below.

The exemplary method flow next determines is a new data element has been created and placed within the workspace, as shown at 306. If not, the presentation system waits, as shown at 308, and then checks again, as shown at 306.

If it is determined at 306 that a new data element has been created and placed within the workspace, then it is determined if this new (initial) data element is in an associative spatial relationship with another data element, as shown at 310. As discussed above, an associative spatial relationship indicating association may be defined in various ways. The particular associative spatial relationship to be used in any particular embodiment may be determined in accordance with instructions as part of the data element interaction engine, FIG. 3, as discussed herein. For an example in which the associative spatial relationship involves abutting relationship of a perimeter/edge of adjacent data elements, as displayed/arranged within the workspace, a exemplary method is shown in FIG. 12 and discussed below.

If the data element considered is determined not to be in an associative spatial relationship, then it is determined whether the considered data element is the last data element within the workspace, such that all data elements currently within the workspace have been considered, as shown at 312. IF so, then the presentation system waits and flow returns to 306, as shown at 308. If, however, the last data element has not been considered, then flow returns to 310, as shown at 312.

If the data element is determined to be in an associative spatial relationship (within the workspace) at 310, then the presentation system references a corresponding data element definitions for the associated data elements, as shown at 314. For example, for two associated number-type data elements, the data element interaction engine may reference with number-type data element definitions stored at 162 of data store 160, as shown in FIG. 3.

Next, the data element interaction engine 156 of the presentation engine 150 of the presentation system 100 causes exchange of information corresponding to the associated data elements according to the stored instructions, as shown at 316. For example, for associated number-type data elements, one of which has been configured by a user to sum values in associated number-type data elements, the data element interaction engine may retrieve the values from the associated data elements and add them to determine a sum.

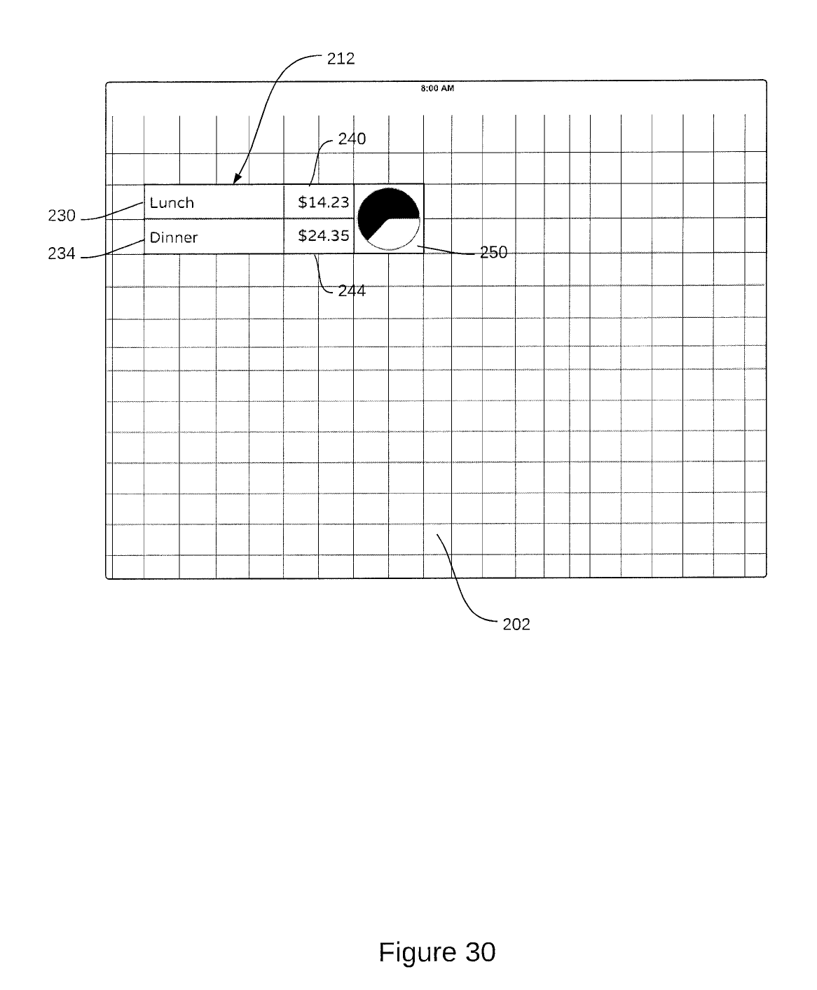

Next, the output engine 158 of the presentation engine 150 of the presentation system 100 creates a visualization of the information corresponding to the associated data elements, according to the stored instructions, as shown at 318. For example, this could be the sum, or for a chart-type data element, this could be a chart reflecting the values/relationships of the numbers in associated number-type data elements. Further, the output engine 158 displays the visualization (e.g., sum or chart in this example), as shown at step 320, and flow returns to step 312, as shown in FIG. 4. A sum visualization 213 is shown in FIG. 6, and a chart visualization is shown in FIG. 30.

FIG. 5 is an image of an exemplary presentation system 100 having a display device, such as a high-resolution, touch-sensitive display screen 114. As shown in FIG. 5, the presentation system, under control of the presentation engine 150, and more particularly the workspace display engine 152, displays a graphical user interface window 200 including an interactive workspace 202 in accordance with the present invention. In accordance with this exemplary embodiment of the present invention, the workspace including a plurality of spaced parallel lines 204 in two orthogonal directions, to define a grid-like array of within the workspace 202. This workspace is effectively a blank canvas upon which a user may create a presentation and/or visualization of information.

In this exemplary embodiment, the grid-like array lays out a plurality of adjacent rectangles, and each data element, as presented within the workspace, has a corresponding rectangular form. However, it is contemplated within the scope of the invention that the grid-like array and/or the data elements may have any other suitable shape, such as triangles, pentagons, hexagons, octagons, etc. All such shapes are referred to generically herein as “boxes.”

FIG. 6 is an image of an exemplary user interface window 200 showing various exemplary information presentations/visualizations created within the workspace 202 in accordance with an exemplary embodiment of the present invention. More specifically, FIG. 6 shows an exemplary multi-photo presentation 203, an associated exemplary map visualization 206, an exemplary task presentation 208 and an associated chart visualization 210, and an exemplary text/number table presentation 212 and associated sum visualization 214. In some cases, a system-created visualization is displayed within workspace, e.g., as an associated data element. In other cases, the system-created visualization is displayed within the graphical user interface, but not within the workspace for arranging data elements.

These exemplary presentations and visualizations are enabled by the predefined and user-configurable “smart” data elements available within the workspace 202. These smart data elements perform predefined tasks to retrieve from an external source and/or exchange information among the data elements in accordance with predetermined data element definitions/configurations/attributes, in accordance with user input, when the boxes are associated by the user. The boxes are associated by a user to trigger such functionality by arranging two or more boxes, as displayed within the workspace, in specified spatial relationship that indicates their association. Any suitable spatial relationship may be used, but generally, a suitable spatial relationship involves close positioning, so that distant position indicates a lack of association, and close positioning indicates association. In the non-limiting illustrative example discussed herein, the predefined spatial relationship indicating associate is a contiguous relationship, so that association is indicated by position data elements within the workspace such that a portion of their perimeters are abutting. Any suitable spatial relationship may be used. By way of example, the associative spatial relationship may allow for modest spacing for “padding” or a “gutter” therebetween, or may provide for common placement within a defined field, or may require partial overlapping relationship, or a 2-D or 3-D (z-axis) visually stacked arrangement.

For data elements arranged by the user within the workspace to have an associative spatial relationship, the workspace causes the data elements to interact with each other enabling a default presentation/visualization and behavior without writing code or manually configuring the data element. In this exemplary embodiment, the workspace gridlines defined rectangular shapes, and the data elements are represented by rectangular shapes, but other geometries may be used.

Generally, the presentation system creates the predefined default presentation and behavior by identifying associated boxes, and determining their types and properties associated with each contiguous data element. The system presents information and creates a corresponding visualization when data elements arranged (by a user) contiguously share the same type or have a common property. Contiguous boxes are deemed associated, and the system processes associated information in a predetermined manner that best suits the corresponding data types. For example, in the photograph presentation 204 of FIG. 6, three individual photograph data elements are arranged in contiguous fashion. thus, these data elements are deemed associated by the system. In accordance with predefined instructions associated with photograph data elements, a tap/touch to select any one of the three photos/data elements results in a visualization including a slide show is containing the three photographic images.

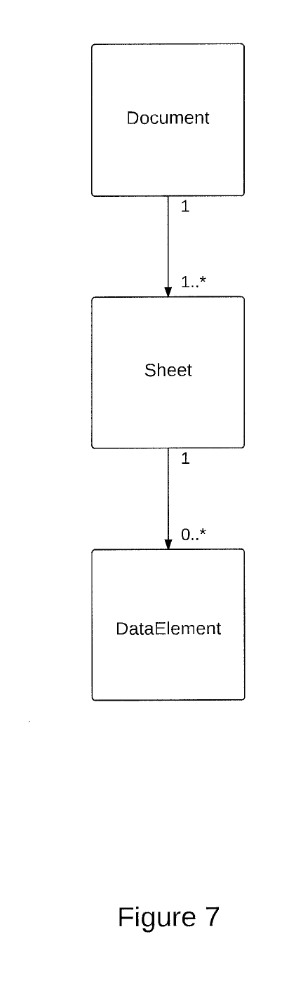

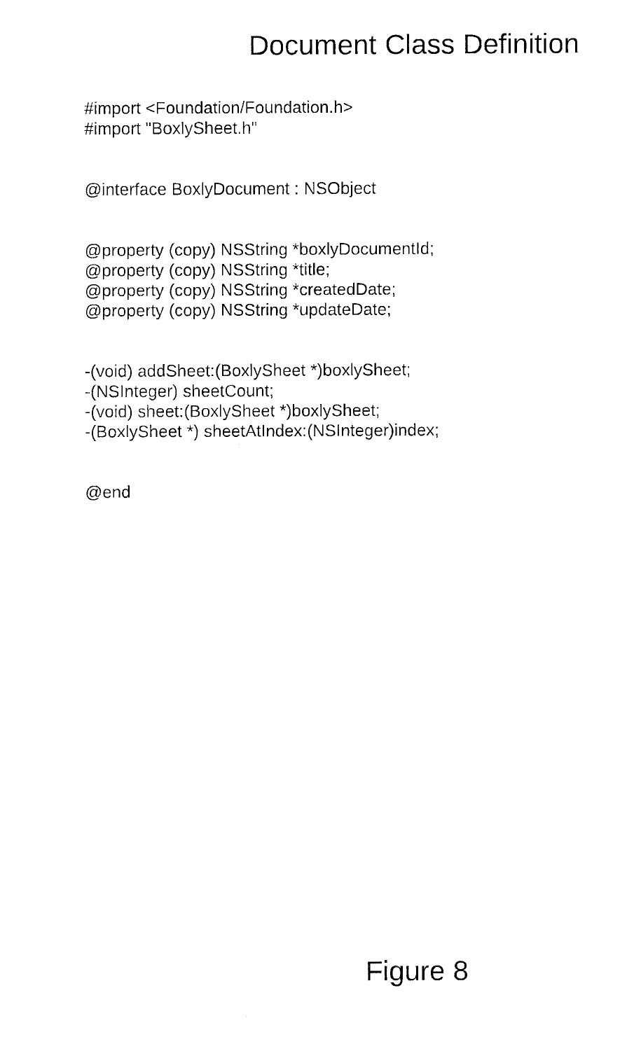

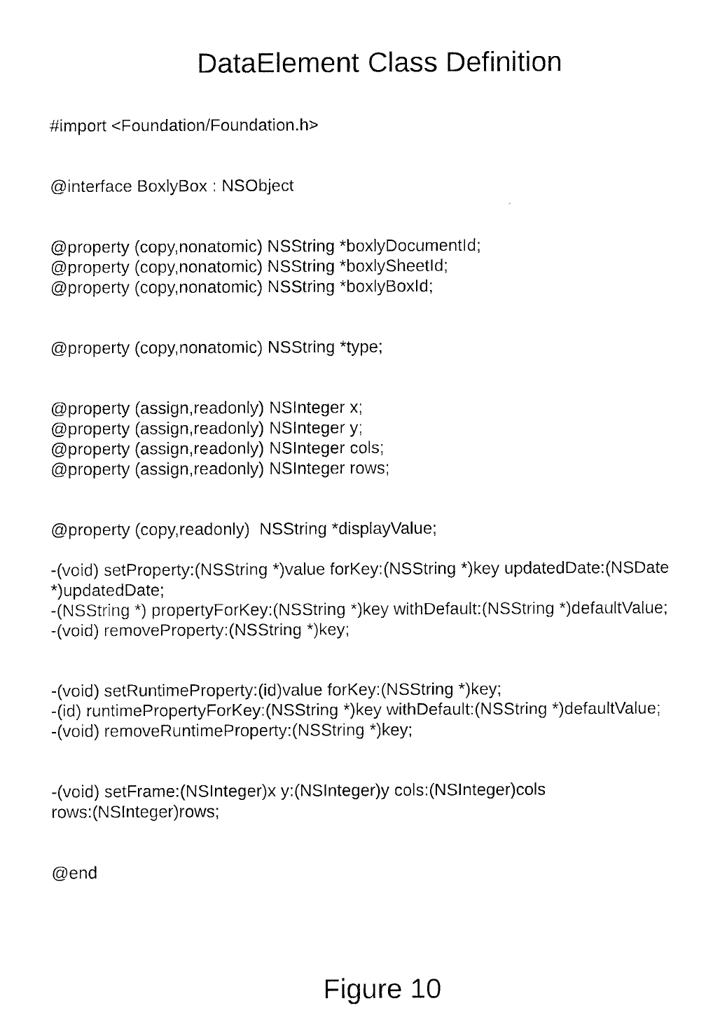

FIGS. 7-10 show the object internals for managing relationships between the Documents, Sheets, and Data Elements in accordance with this exemplary embodiment. Referring now to FIG. 7, the system defines a document as composed of a Document object which has one or more Sheet objects. A Sheet object has zero or more Data Element objects. As will be appreciated from FIG. 10, each Document has a respective x and y position as well as a number of columns (cols) and rows the box will occupy. Further, as shown in FIG. 10, each Data Element captures a set of properties that define the details used to present the user interface. For example, a Data Element with type TEXT will have properties for the text, font name, text alignment, font size, background color, and foreground color.

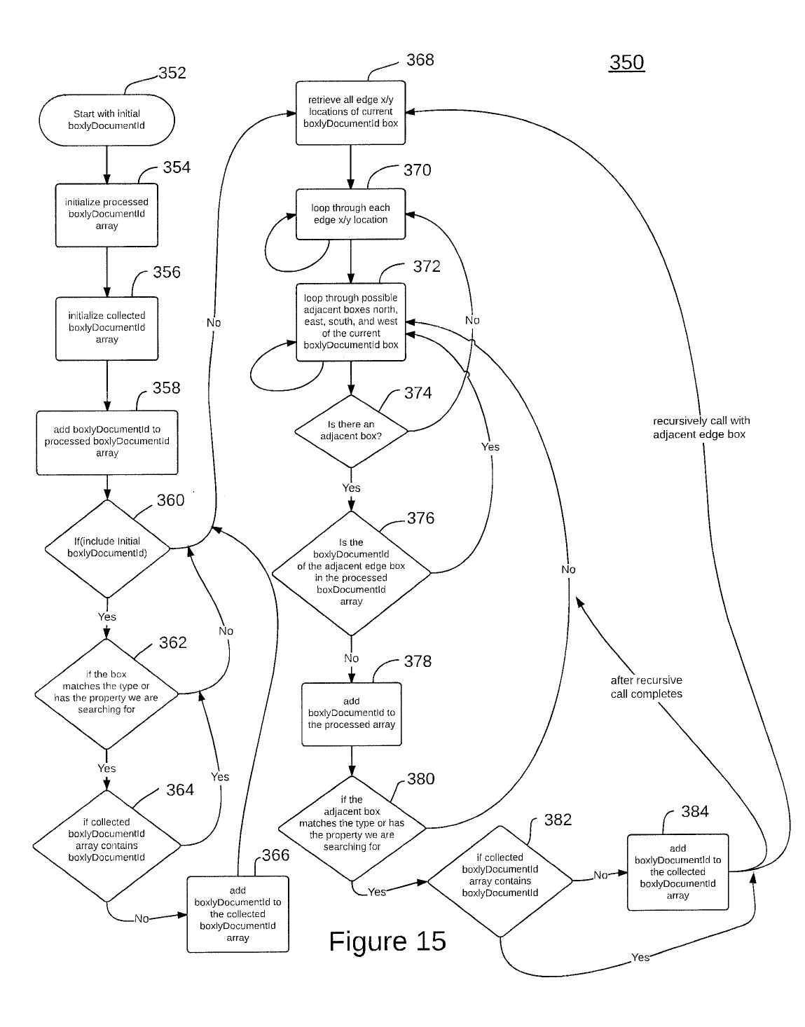

FIG. 15 is a flow diagram 350 illustrating an exemplary method for finding associated data elements, after a user has interacted with the workspace to arrange a plurality of data elements (sometimes referred to in this example as “boxes”) in a particular spatial relationship. This exemplary method determines which of the data elements/boxes have been associated by the user, in this example, by arranging them in a contiguous relationship so that portions of their sides abut one another as displayed within the workspace. This abutting relationship indicates association, and thus signals to the workspace/system that information associated with the associated data elements should be exchanged or otherwise processed, e.g., to create an information visualization.

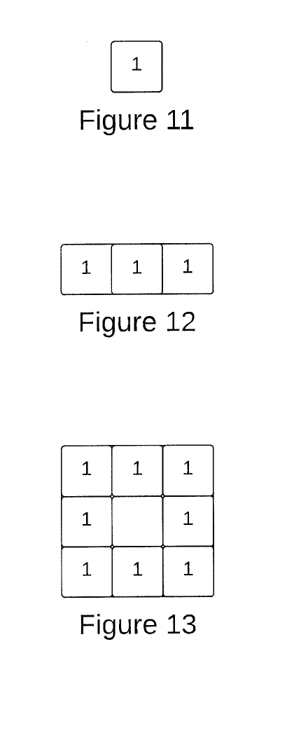

Generally, the method of FIG. 15 is used to locate associated boxes/data elements contiguous to an initial/starting box/data element. Generally, the method uses the edges of each data element to identify neighboring (in a contiguous sense) boxes for processing. For illustrative purposes, examples are shown in FIGS. 11-14. In those figures, a box with the number ‘1’ identifies a box that is used to look for associated neighboring boxes. For example, a 1×1 box has only one box used for determining neighbors as seen in FIG. 11. A 1×3 box has three boxes used for determining neighbors as seen in FIG. 12. But in FIG. 13, a 3×3 box only looks for neighbors on the outside edges of the box.

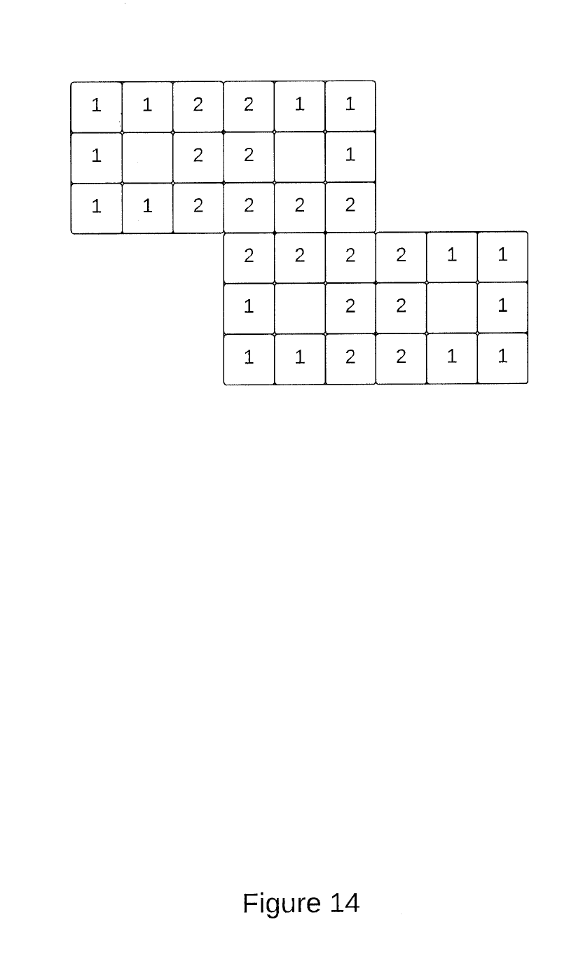

For further illustrative purposes, in FIG. 14 four boxes are shown next to each other, each of which is a 3×3 box similar to that shown in FIG. 13. The number ‘1’ again identifies the edges, and the number ‘2’ identifies where an associated neighboring box has been found.

Referring now to FIG. 15, the exemplary method is performed by the presentation engine 150 to identify related data elements. This exemplary recursive method traverses data elements that have a common type, or a common property. In alternative embodiments, a similar method is performed to traverse all associated data element. The method starts and then initializes a processed BoxIds array, as shown at 302 and 304 in FIG. 15. This is performed by the data element interaction engine 156.

This exemplary method will find associated data elements for an initial data element having an initial boxlyDocumentID. Referring now to FIG. 15, the method starts with selection of the initial boxlyDocumentId, as shown at step 352. A Boolean expression identifying whether the current boxlyDocumentID should be checked for a match, and a list of cellTypes and property names, may be passed into a workflow.

Next, the system initializes as an empty array the processed boxlyDocumentId array that holds the boxlyDocumentId that has already been processed, as shown at 354. This array contains a list of boxlyDocumentIds that have already been processed, so that each boxlyDocumentId can be processed only once.

The system then initializes the collected boxlyDocumentId array that holds matching boxlyDocumentIds that are found while traversing through the associated data elements/boxes, as shown at 356. More specifically, the system initializes the collected boxlyDocumentID array as an empty array. This array contains a list of boxlyDocumentIds that match the passed-in cellTypes or property names.

The system then adds the first (starting) boxlyDocumentId from step 302 to the processed boxlyDocumentId array, as shown at 358. Accordingly, the data element will not be processed duplicatively.

The system next determines whether to determine if this current boxlyDocumentId is a cellType or property match, as shown at 360. This is done based on a specific type or a specific property of the processed data element, and is done by checking the passed-in Boolean expression. For example, the system may exclude the initial boxlyDocumentId if the starting box was a chart-type data element and the chart requires finding of associated number-type data elements. By way of further example, the system would include the initial boxlyDocumentId if the first box was an image-type data element and the system is searching for image-type data elements. If there is a match, then flow continues to 362. If not, flow proceeds to 368.

Next, it is determined at 362 if a BoxlyBox with the boxlyDocumentId matches a specific cellType or contains a specific property that is being searched for. If so, then flow continues to 364. If not, then flow proceeds to 368.

At 364, the method checks to determine whether the collected boxlyDocumentId array already contains the current boxlyDocumentId being considered. If so, then flow proceeds to 368. If not, then flow proceeds to 366. At 366, the current boxlyDocumentId is added to the collected DocumentId array. Flow then proceeds to 368, which is the start of a recursive loop.

At 368, the system determines all of the x/y coordinate locations of all edges for the current boxlyDocumentId box, as will be appreciated from FIGS. 11-14. As shown in FIG. 10, each BoxlyBox has x, y, columns, and rows properties. These values define the physical space allocated to the box within the workspace. These values are also used to find the outermost x/y locations of the box. The system iterates through the list of edges collected at 368 until the edge location set=0, meaning all of the edge x/y locations have been processed, as discussed in further detail below.

When the list of edge x/y locations is exhausted at 370, flow returns to the calling method. This is how the recursive call is exited. Flow then continues to 372.

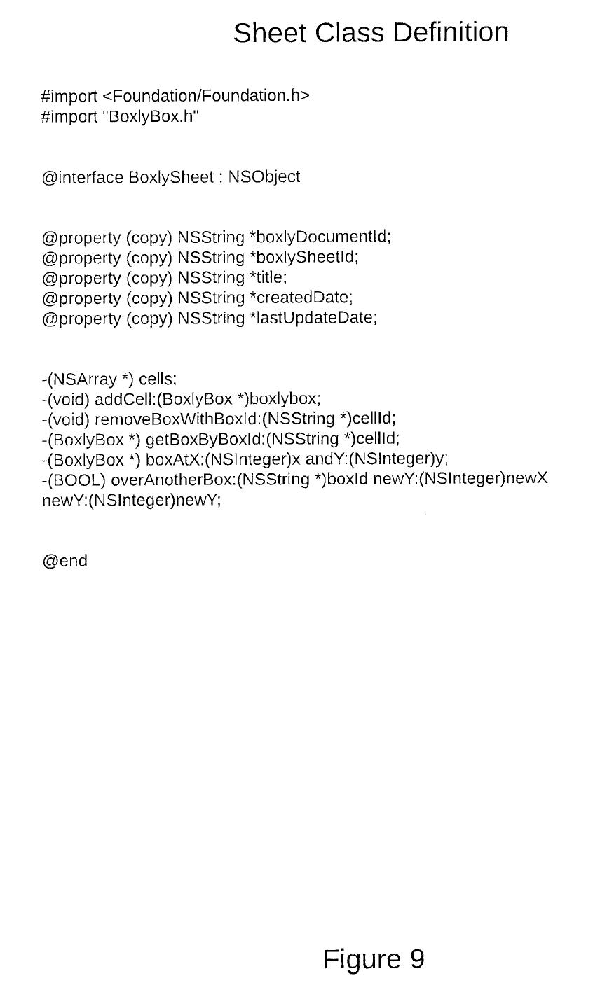

As shown at 372, for each edge x/y location the system checks to see if there is an adjacent cell, e.g., above, below, to the right, and to the left for a workspace made up of rectangular elements laid out in a rectangular grid/workspace. A loop considers each possible adjacency to search for adjacent boxes. The system calls the boxAtX:andY: method in the BoxlySheet class in shown in FIG. 9. This method returns a BoxlyBox.

The system then checks to see if a BoxlyBox was retrieved at 372, as shown at 374. If not, flow continues to 370.

If so, flow continues to 376. At 376, it is determined if the retrieved BoxlyBox is in the processed boxlyDocumentId array. If so, flow returns to 372. If not, flow proceeds to 378.

At 378, the adjacent box's boxlyDocumentId is added to the processed boxlyDocumentId array so that this particular boxlyDocumentId is not processed again. Flow then proceeds to 380.

At 380, it is determined whether the BoxlyBox with the boxlyDocumentId matches the specific type or contains the specific property sought. If so, it is determined whether the collected boxlyDocumentID array contains the boxlyDocumentId, as shown at 382. If so, then flow proceeds to 384, and the boxlyDocumentId is added to the collected boxlyDocumentId array, and flow returns to 372 (to recursively process the adjacent boxlyDocumentId to look for other adjacent boxlyDocumentIds that match the sought-after cellTypes or property names, until completion) or 368 (to recursive process a next possible adjacency, until all adjacency opportunities have been exhausted). If not, then flow returns to 372 or 368 directly. This recursive process continues until all edge x/y locations for the original boxlyDocumentId passed in have been processed at 370.

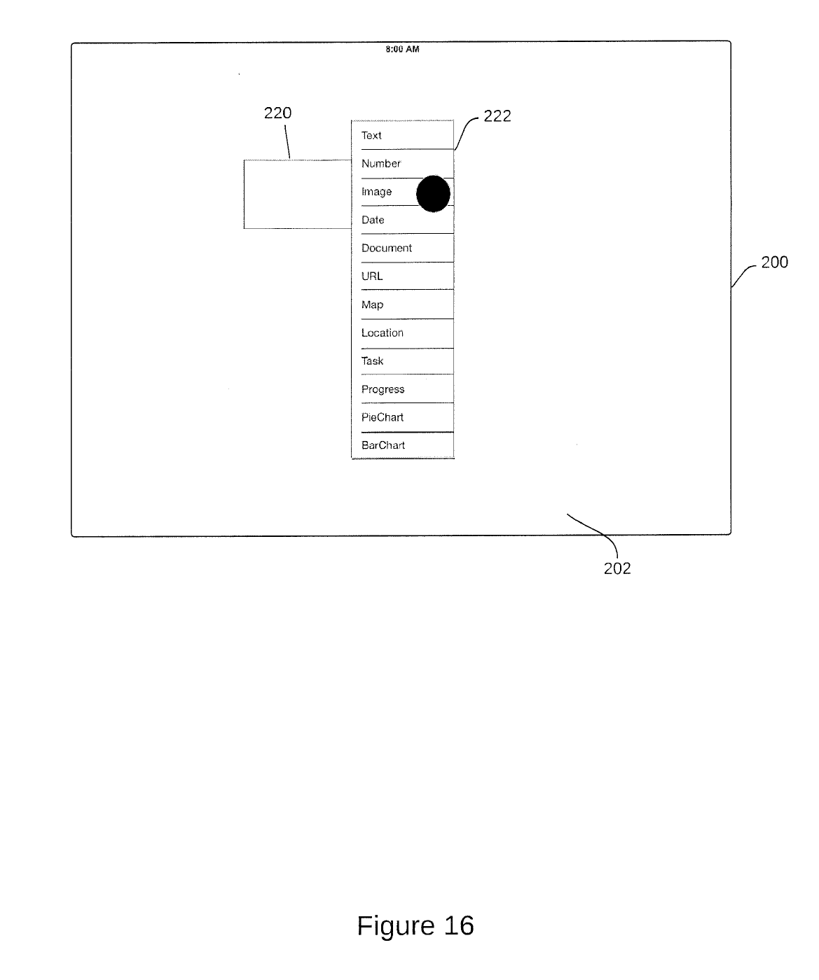

As discussed above, FIG. 6 shows an exemplary multi-photo presentation 203. Accordingly, FIG. 6 shows a workspace after exemplary interaction by a user. FIGS. 16-44 show various user interface windows showing how the workspace may be used to create data elements, to associate data elements, and to create information presentations and visualizations in accordance with the present invention.

Referring now to FIG. 16, a user may interface with a blank workspace (see FIG. 5) displayed by a presentation system including a touchscreen interface by simply touching an empty portion of the workspace. The touch results in creation of a new data element 220 (in the form of a box, in this example), which is displayed within the workspace. The user may drag his finger to select a region of the workspace that includes a plurality, extending in one or two dimensions, of the individual boxes defined by the gridlines. This establishes placement (including x/y coordinates and sizing) of the new data element within the workspace.

This touch is recognized by the user input engine 154 of the presentation engine 150. The user input engine resultingly communicates with the workspace display engine 152, which in turn causes display in the workspace 202 of a menu 222 of data element types, as shown. In this example, the data element types including: Text, Number, Images, Data, Document, URL, Map, Location, Task, Progress, PieChart and Bar Chart. Each of these data element types is predefined within the system. Such definitions include not only parameters, some of which may be configured by user input, but also logic as to which data element types to interact with, how to exchange information with other data elements, how/whether to retrieve information from an external data source, how to create a visualization, etc. By way of example, a data element may be configured to retrieve content/values from an external data source through a web service call return JSON, which content/values are then processed to identify data types and associate them with corresponding data elements, which may be recognized automatically. This retrieval may be performed automatically and repeatedly, e.g., to provide for data element/presentation/visualization content that changes dynamically, over time. Optionally, data may be pushed back from the presentation system to the remove content system or another remote computing system/web service. The definitions of the various data element types are stored within the data element definitions data store 162 of data store 160.

Though in this example each data element type is predefined, in alternatively embodiments, a data element may have a generic type and the type is inferred from the user input provided in associated with the data element according to predefined rules (e.g., text, number, phone number, email address).

The example of FIGS. 16-18 relate to creation of an image-type data element, and the user is shown as having selected Image from the menu (as represented for illustrative clarity by the touchprint dot shown in FIG. 16). This input is received by the user input engine 154, which communicates with the workspace display engine 152.

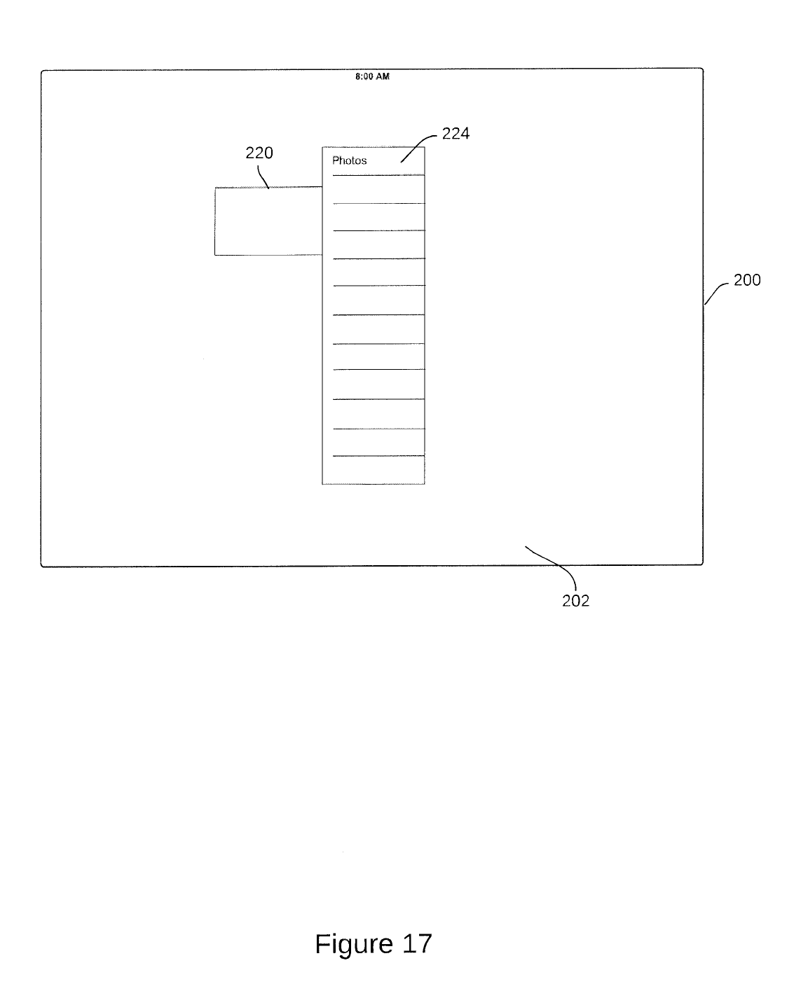

In response to such input received by the user input engine 154, the workspace display engine 152 responsive displays a list of image sources 224 available for choosing the image content for the created data element 220, as shown FIG. 17. This list could also contain, for example, options such as direct access to the camera for taking a new picture, access to cloud based services such as Dropbox®, or a list of local apps for retrieve the image.

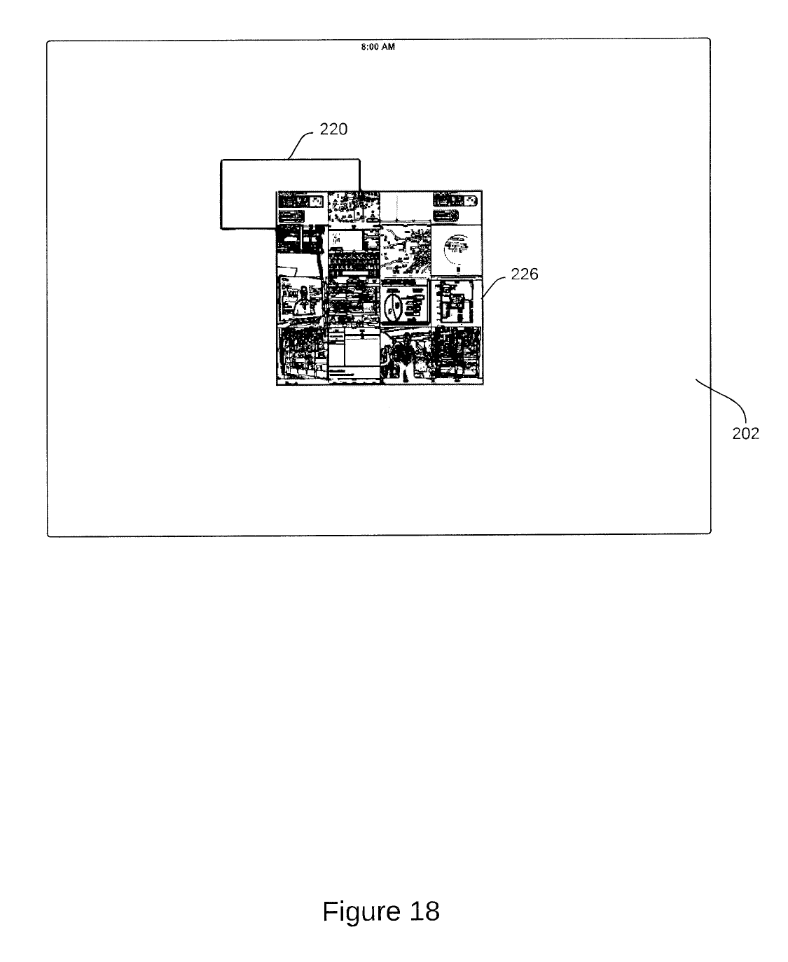

By tapping the Photos source type in FIG. 17, the user input engine and workspace display engine responsive display an image menu 226, e.g., as retrieved from an image storage location, as shown in FIG. 18. The user can select an image by tapping a displayed image.

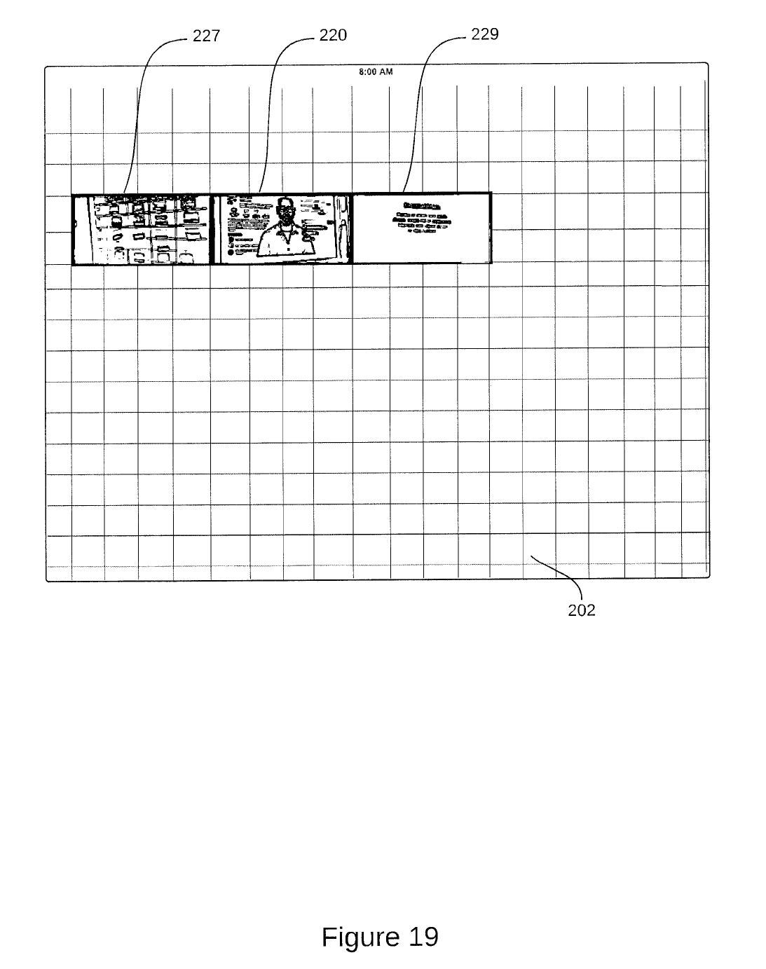

Once the image has been selected in FIG. 18, the menu in FIG. 17 is dismissed, and the selected image is added to the image data element box 220 and displayed in the workspace (document), as shown in FIG. 19.

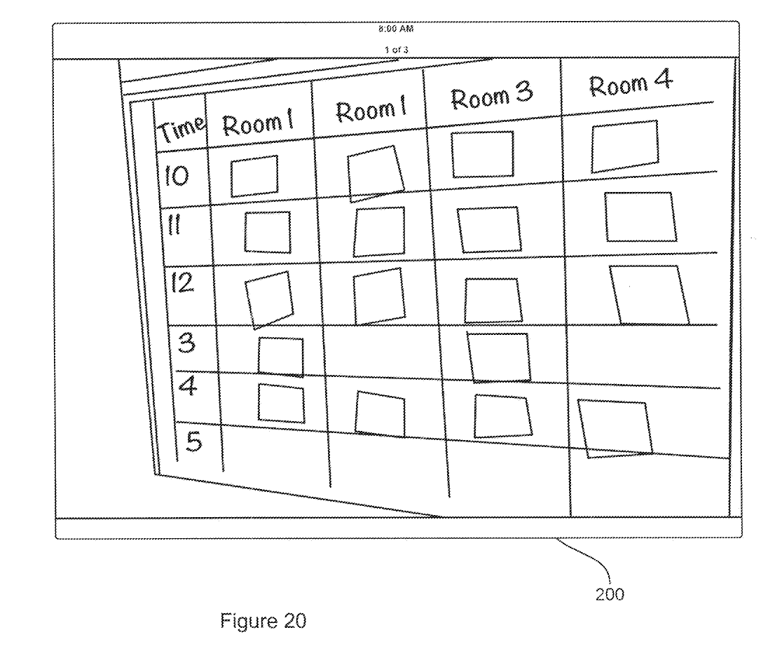

FIG. 19 further shows a presentation 204 of information that includes two additional image data element boxes 227, 229. These additional image-type data elements 227, 229 were created in a fashion similar to that of image data element box 220, as described above. These image boxes 220, 227, 229 could exist at distinctly separate locations, in unassociated fashion, within the workspace 202. However, FIG. 19 shows the three image data element boxes 220, 227, 229 after a user has manipulated them into an array of contiguous images, specifically, a 1×3 array. The boxes are associated in that the user has positioned them within the workspace such that they are contiguous, in that their edges abut one another. This spatial relationship signals that they are associate, which signals to the presentation engine to treat them as related. More specifically, the data element interaction engine 156 may processes these associated data elements (and/or associated date), e.g., using the method described above with reference to FIG. 15, to determine that they are associated. Once associated, the presentation engine's output engine 158 creates a visualization creates a predefined display of content, according to instructions/logic associated with the image-type data elements, as reflected in the data element definitions 162. In this particular embodiment, the information visualization created by the output engine 158 for associated image-type data elements is a slideshow of the images of the associated data elements. FIG. 20 shows a user interface window 200 displaying a first image of the slideshow, and notes that there are 2 additional images in the slideshow, as reflected in the “1 of 3” header. Accordingly, the user may swipe to the left or right to navigate through the images of the slideshow, as is well known for touchscreen style interfaces.

The image-type data element could be configured with any desired type of visualization. By way of alternative example, the images could be presented in a tiled format, a filmstrip forma, a scattered format, a collage format, etc.

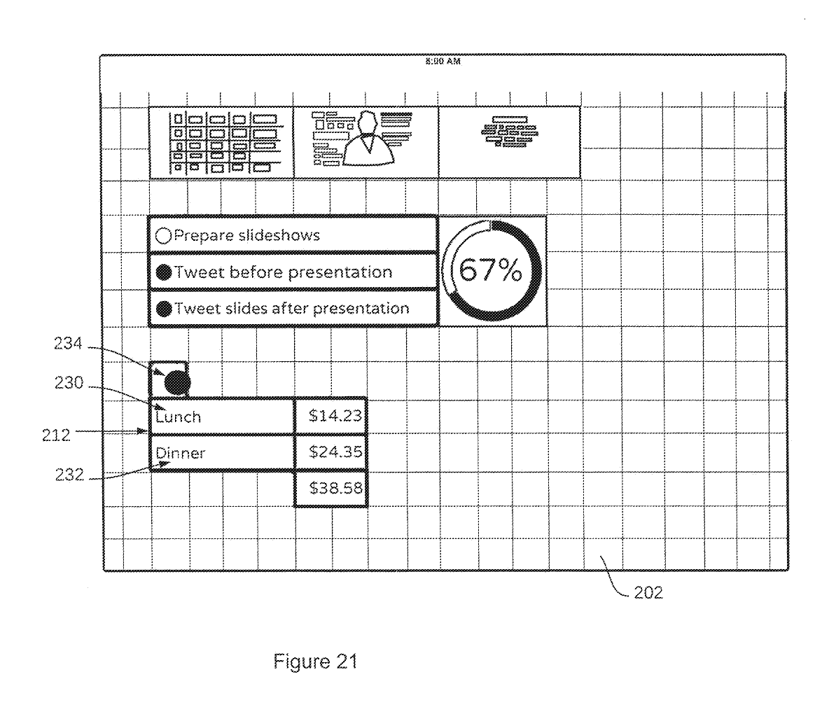

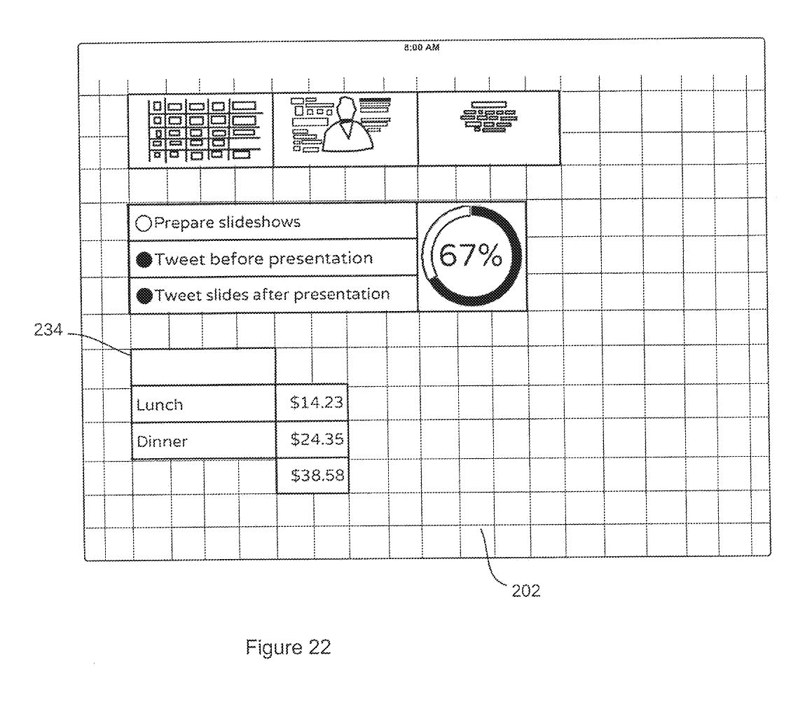

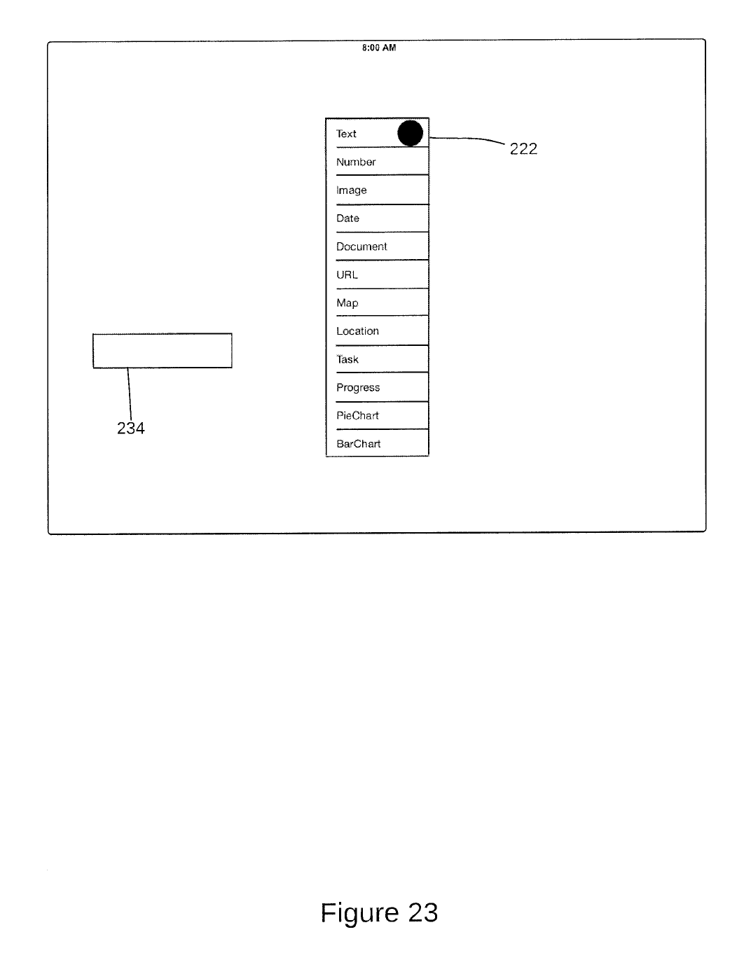

Referring again to FIG. 6, FIG. 6 shows an exemplary text/number table presentation 212. FIG. 21 shows two existing text-type data elements 230, 232 within the workspace 202, and illustrates creation of an additional text-type data element 234. As described above, the new text-type data element 234 can be created by first touching a finger down on the workspace 202 in a location that currently does not contain an existing box as shown by the touchprint in FIG. 21. While keeping the finger pressed against the device's screen, the user can drag the finger to the right and/or down to enlarge the size of the text-type data element box as shown in FIG. 22. Lifting the finger at this point will cause display of the menu 222 of data element type, and in this example the user has tapped the Text menu option to select a text-type data element, as shown by the touchprint in FIG. 23. Again, these functions are managed by the workspace display engine and the user input engine.

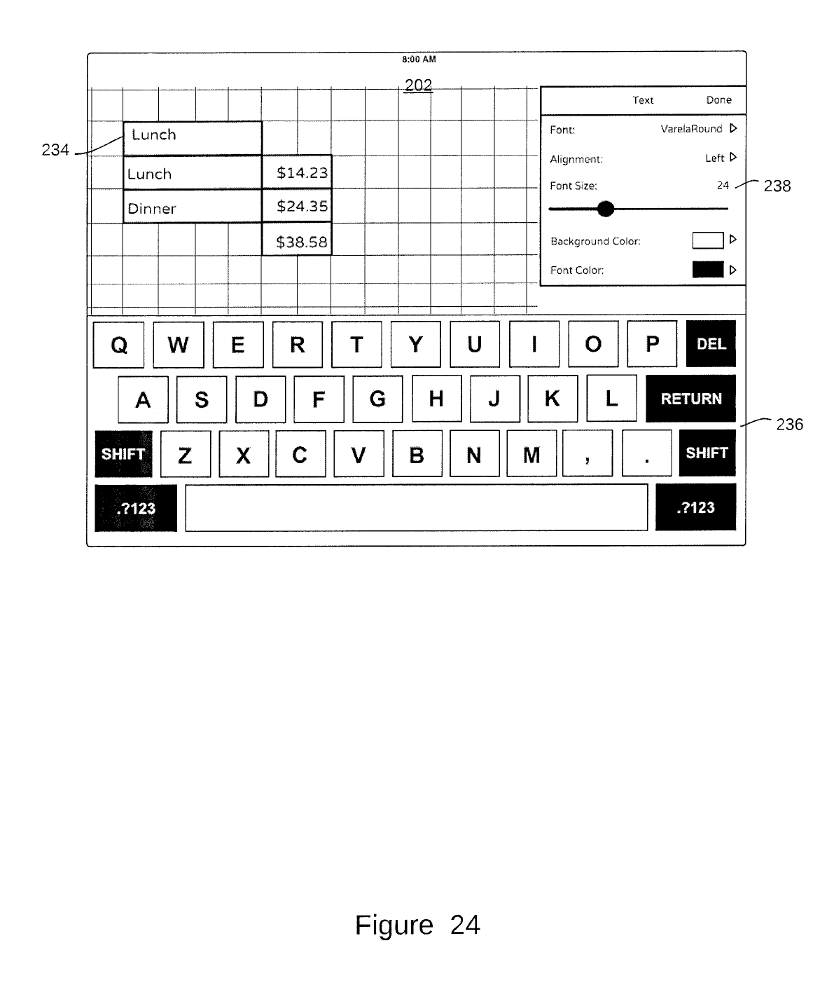

Once the text-type data element has been selected, a text box is created and the text box is added into the workspace/document at the defined location. In accordance with the data element definitions 162, and under the control of the workspace display engine 152, when a text-type data element is created a keyboard 236 is displayed as well as a property sheet 238 associated with a text-type data element, as shown in FIG. 24. The user-configurable parameters identified in the property sheet 238 are a function of information contained in the corresponding data element definition, and are provided by the workspace display engine 152.

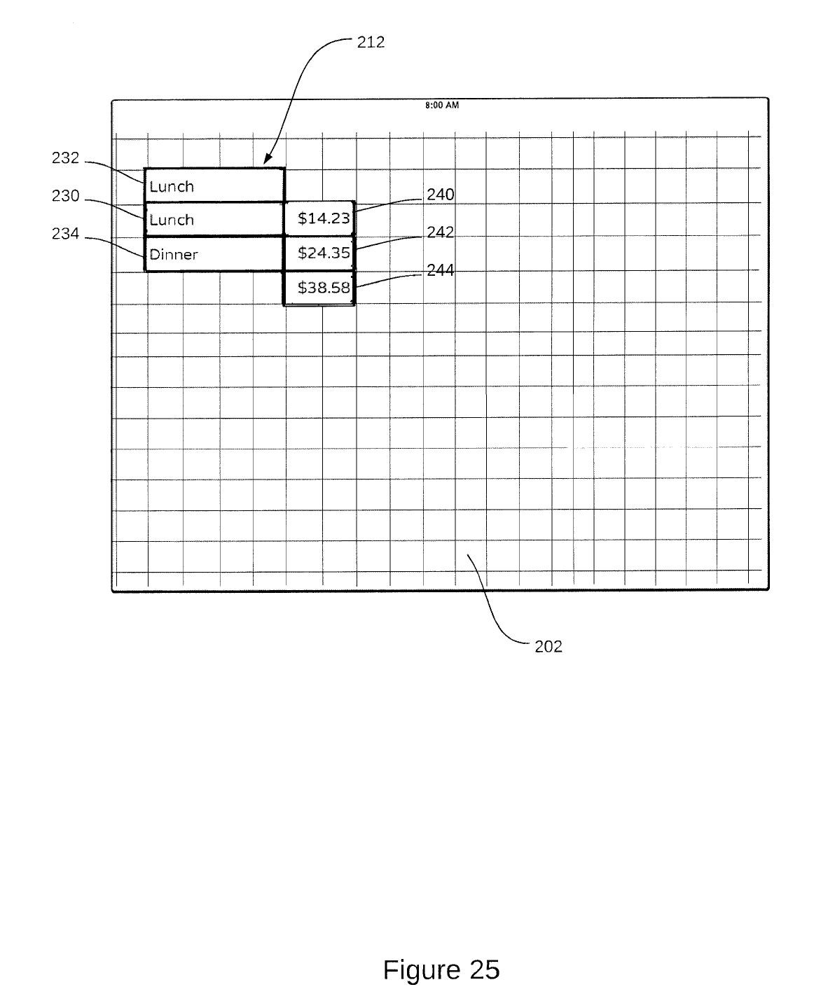

The user can use the keyboard 236 to provide text content for the text-type data element. The user's input is received by the user input engine, stored in associated with the data element 234 in the data element configuration input data store 164, and is displayed in the workspace 202 by the workspace display engine 152, as will be appreciated from FIG. 24. The editing of the text-type data element can be completed by selecting “done.” After the “done” button is pressed, the keyboard 236 and property sheet 238 are dismissed as shown in FIG. 25.

In accordance with the methodology discussed with reference to FIG. 15, it may be determined that text-type data elements 230, 232 and 234 are associated (because they are arranged in contiguous fashion within the workspace). These contiguous data elements form the presentation 212 (which in this example further includes number-type text boxes, discussed below). However, in accordance with the data element definition 162 for the text-type data elements, the data element interaction engine 156 may determine that no information exchange, no information retrieval, and no creation of any corresponding information visualization is appropriate.

As will be further appreciated from FIG. 25, the exemplary presentation 212 further includes number-type data elements 240, 242, 244 within the workspace 202.

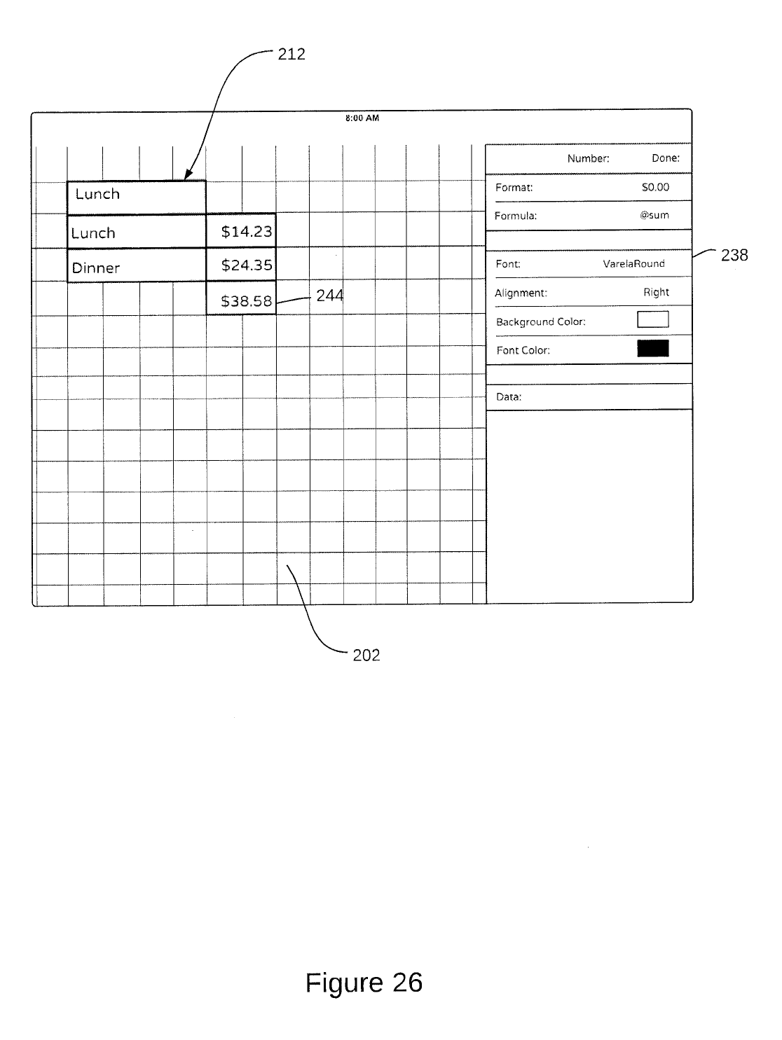

Number-type data elements 240 and 242 can be created in a manner very similar to that described above. In this case, the user has provided dollar amounts of $41.23 and $24.35 as input/content for those number-type data elements, as shown in FIG. 26. Accordingly, the content of these boxes is static.

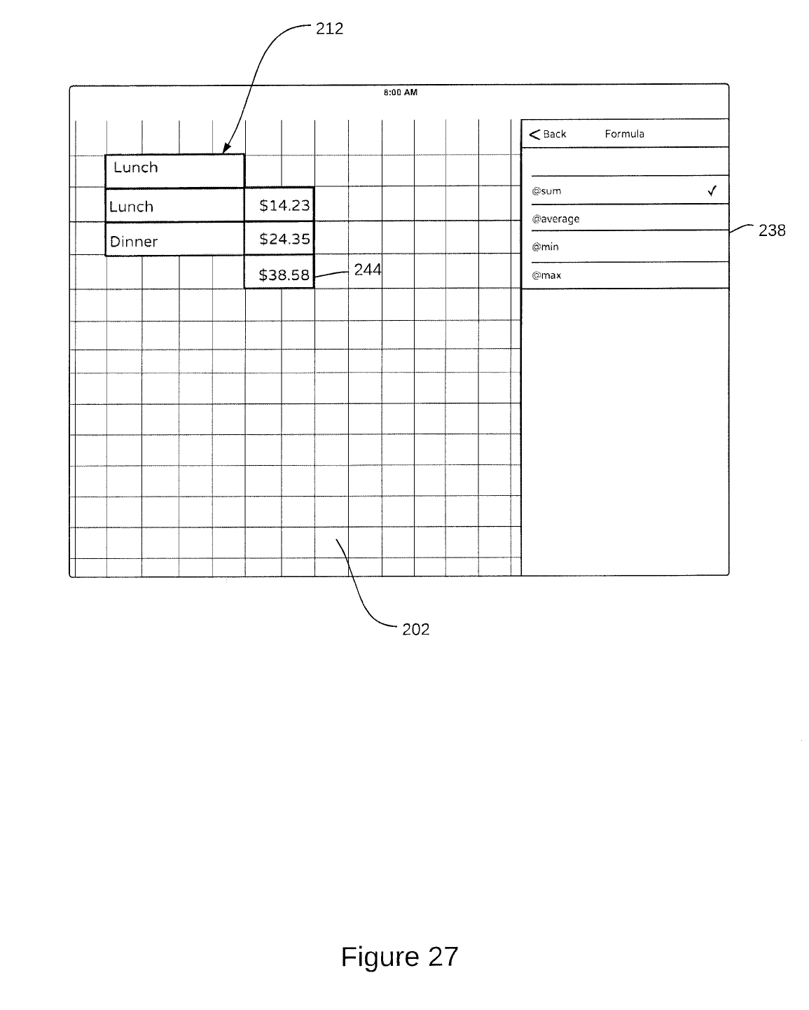

However, the exemplary presentation further includes another number-type data element 244, for which the user has provided as content a formula by making an appropriate selection from the property sheet 238 for number-type data element 244, as shown in FIG. 26. More specifically, tapping on the formula row in the property sheet 238 will display a list of formula options, as shown in FIG. 27. These options are available due to the definition of a number-type data element as defined in the data element definitions data store 162.

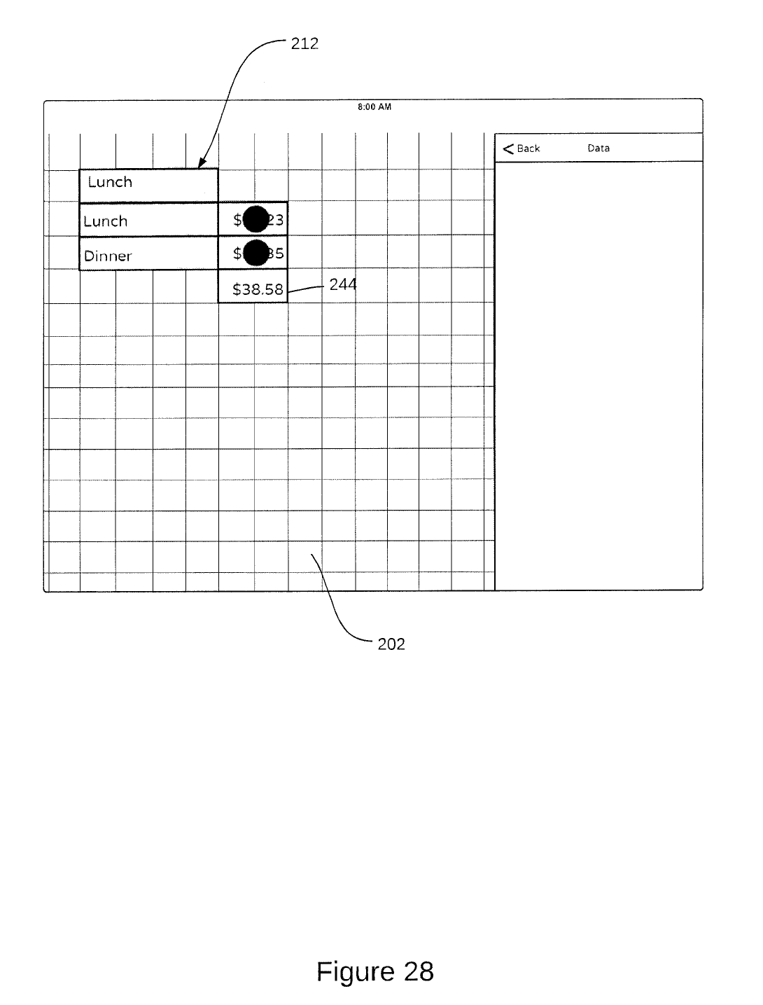

Tapping on the Data option in the property sheet 238 will highlight the associated data elements being used in the formula, and highlighting them with a filled marker as shown in FIG. 28. These can be toggled on and off for inclusion or exclusion by tapping the marker.

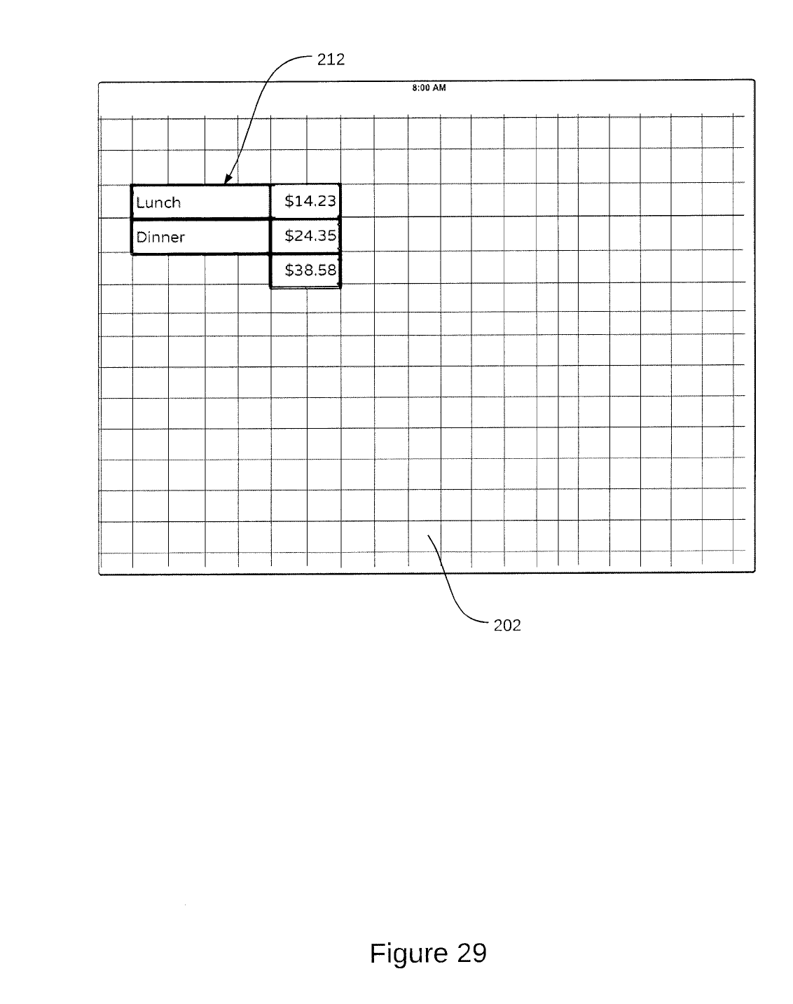

In accordance with the methodology discussed with reference to FIG. 15, it may be determined that number-type data elements 240, 242 and 244 are associated (because they are arranged in contiguous fashion within the workspace). These contiguous data elements form a number type presentation 212 (which in this example further includes text-type boxes, discussed below). However, in accordance with the data element definition 162 for the number-type data elements, the data element interaction engine 156 may determine that information exchange is required and that the associate formula (“@sum”, indicating a sum function) is to be executed by summing the numerical values in the associated boxes and displaying the result in the formula-containing numerical-type data element. Accordingly, when data element 244 is moved into contiguous relationship with data elements 240 and 242, the data element interaction engine calculates the sum, and the output engine 159 displays the result in data element 244, as shown in FIG. 29. This is performed automatically upon the user's movement of the data element 244 into contiguous relationship with data elements 240 and 242 within the workspace 202. Thus, the presentation 212 includes a system-created sum visualization 214 of the data, namely, the sum displayed in number-type data element 244.

FIG. 30 shows similar text-type data elements 230, 234 and similar number-type data elements 240 and 244, but further shows a PieChart-type data element 250, which can be created in a manner similar to that described above.

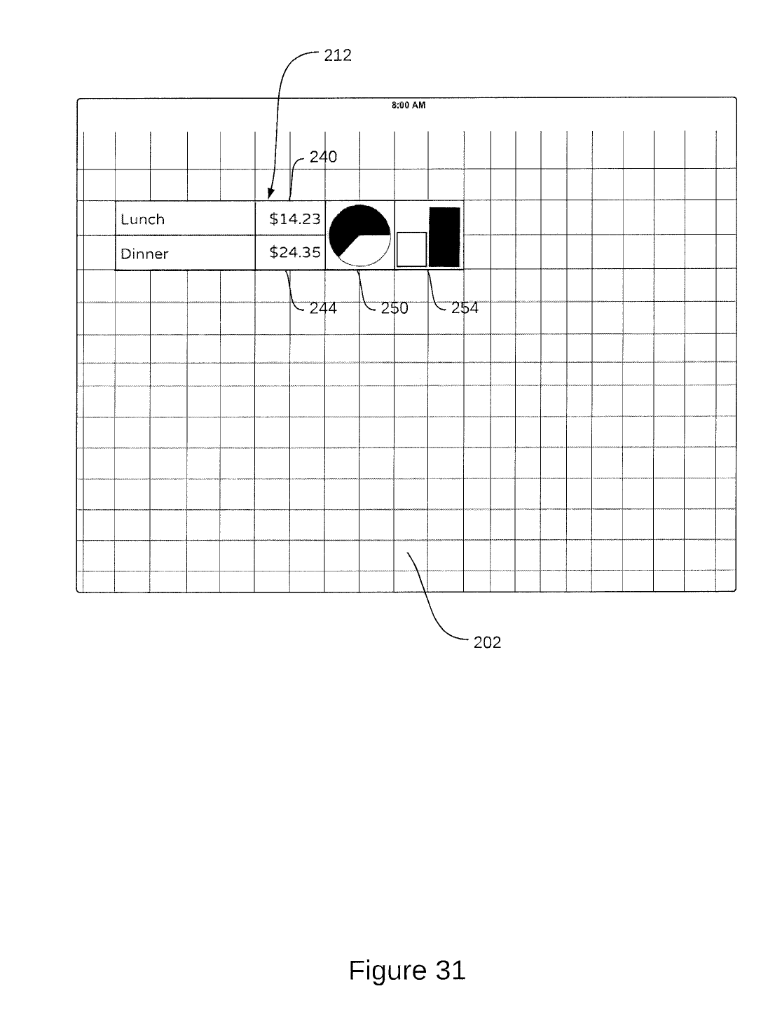

In accordance with the methodology discussed with reference to FIG. 15, it may be determined these data elements are associated (because they are arranged in contiguous fashion within the workspace). In accordance with the data element definition 162 for the PieChart-type data element, the data element interaction engine 156 may determine that information exchange is required and that the associated numerical values in the associated number-type data elements are to be displayed in the PieChart-type data element, as shown in FIG. 30. Accordingly, when data element 250 is moved into contiguous relationship with data elements 240 and 244, the data element interaction engine references the numerical data and the output engine 159 displays the resulting chart in data element 250, as shown in FIG. 30. This is performed automatically upon the user's movement of the data element 250 into contiguous relationship with data elements 240 and 244 within the workspace 202. FIG. 31 shows a BarChart-type data element 254 including a bar chart information visualization corresponding to the same data, and created in a similar fashion. The charts are system-created visualizations of the data in the associated data elements.

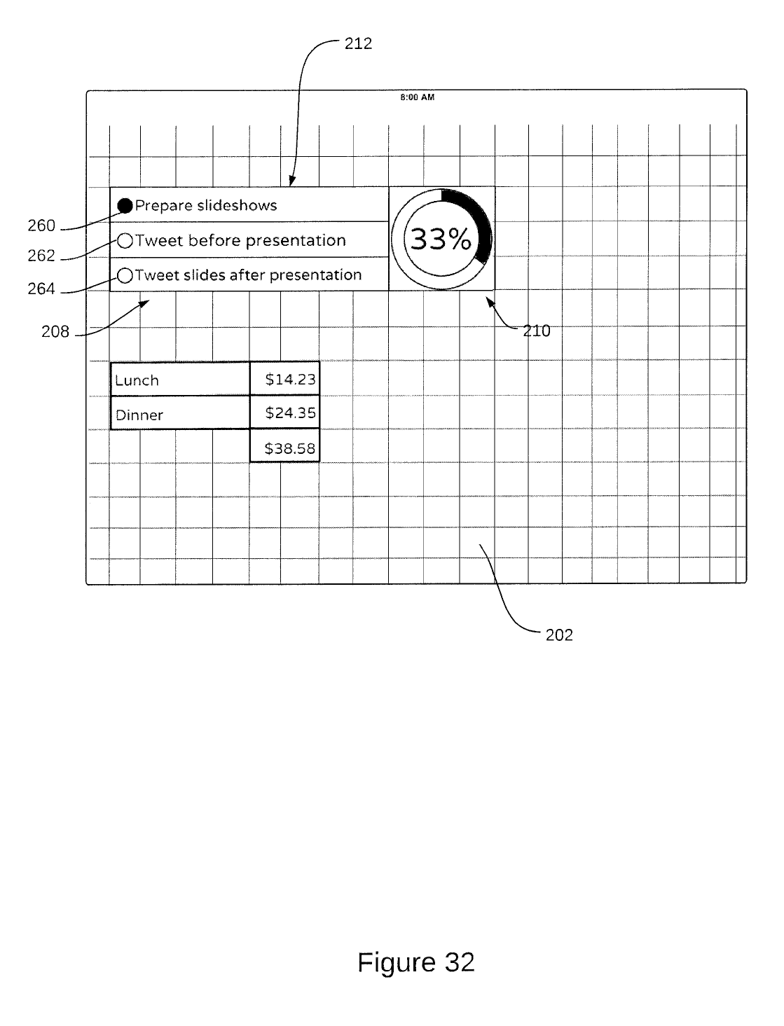

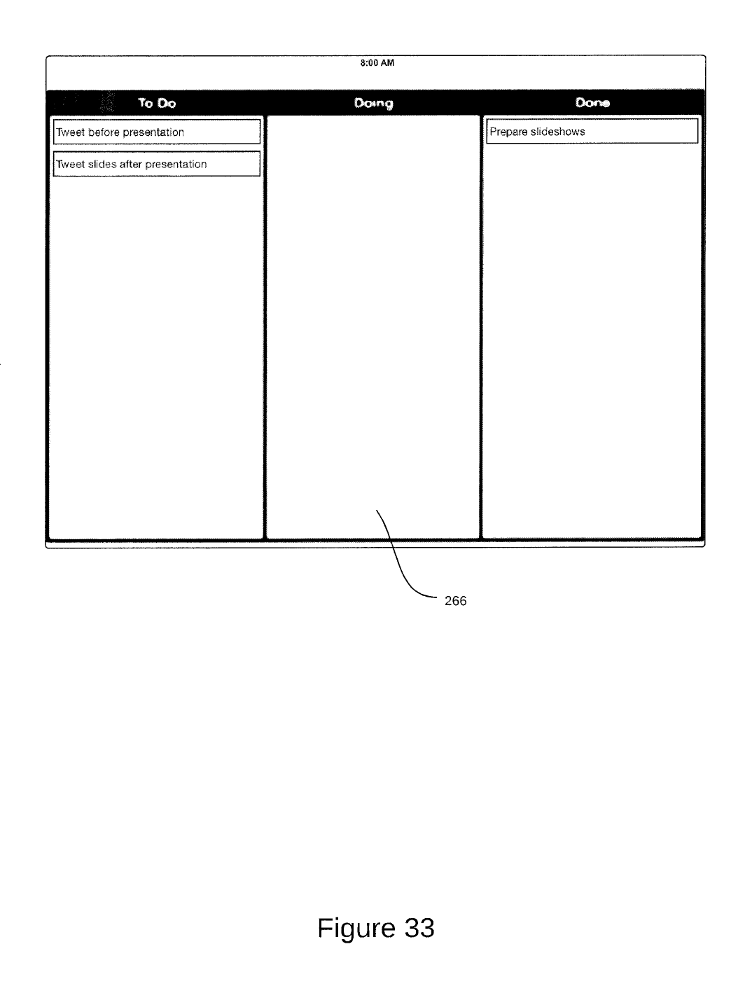

Referring again to FIG. 6, and to FIG. 32, an exemplary task presentation 208 and an associated chart visualization 210 are shown. More specifically, three associated task-type data elements 260, 262, 264 are shown associated, in contiguous spatial relationship. These data elements may be created and associated in a manner similar to that described above. The task-type data elements are associated, the workspace display engine 152 display (in response to a tap) a task completion panel 266, as shown in FIG. 33. This panel 266 allows a user to drag the defined tasks into TO DO, DOING and DONE columns to reflect each task's completion status, which is then reflected in the form of “checked” checkboxes or other analogous imagery.

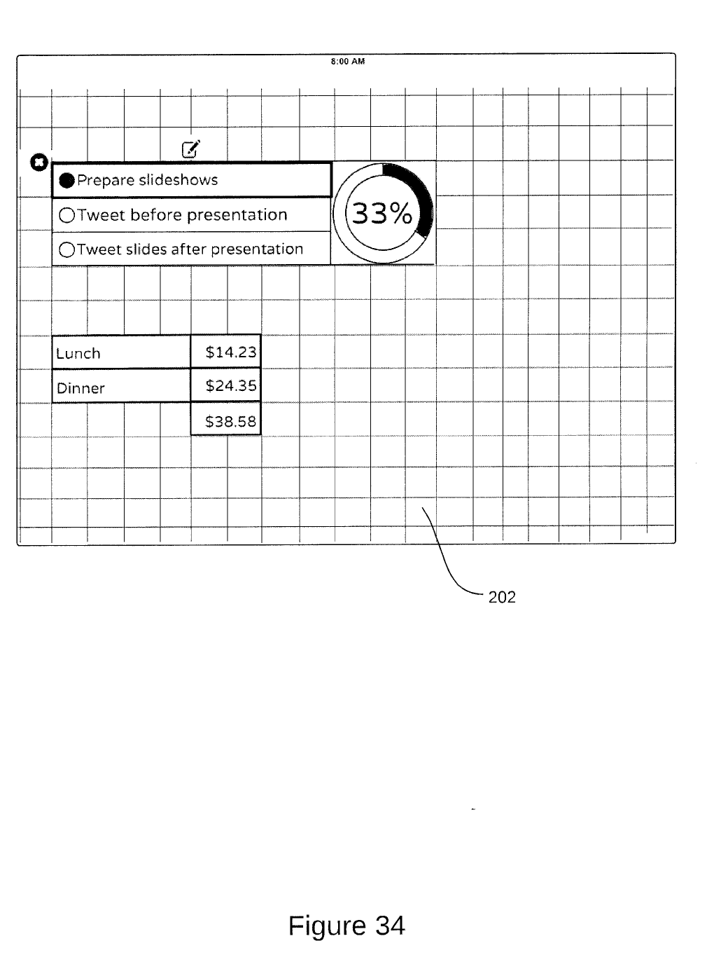

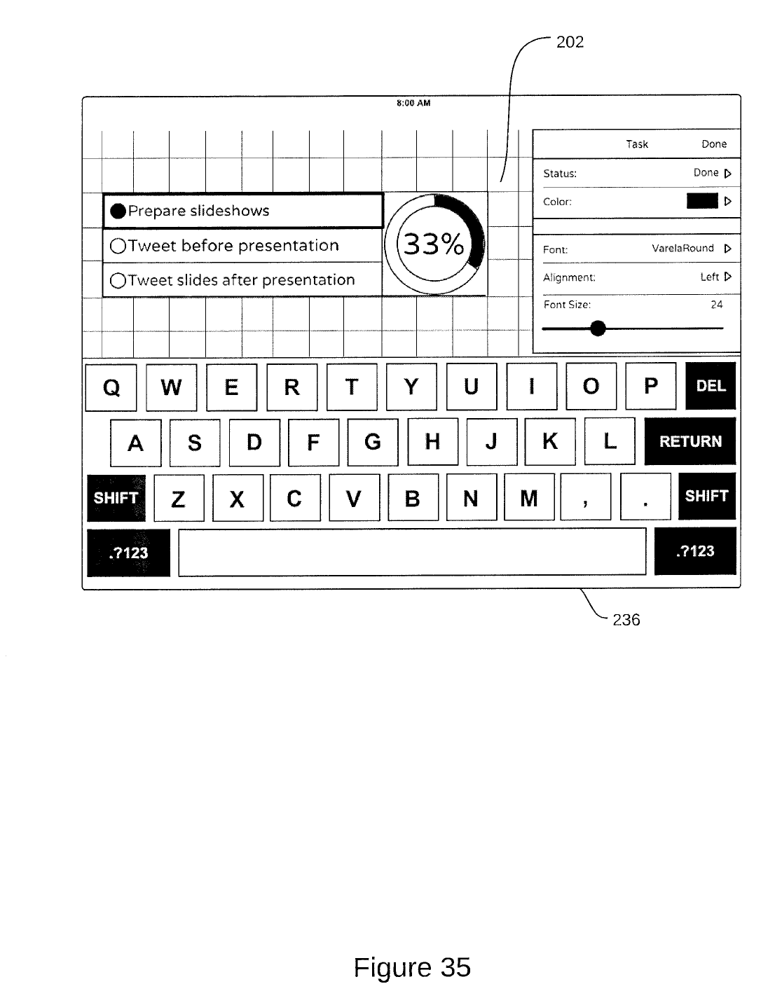

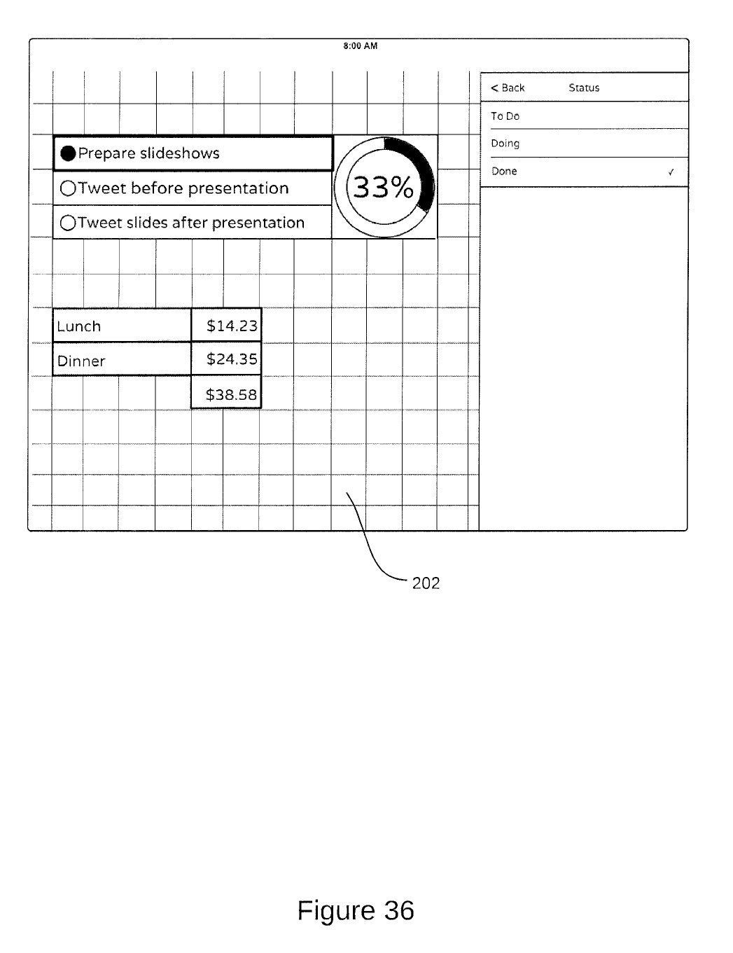

For example, in FIG. 32, three tasks boxes are shown, with the “Prepare slideshows” task marked as completed. A long press on task box displays a menu including an edit icon as shown in FIG. 34. Tapping the edit icon displays the keyboard 236 for editing the task's text and the property sheet for the task box as shown in FIG. 35. Tapping the Status row of the associated property sheet 238 in FIG. 35 displays the list of task box status types as shown in FIG. 36. Changing the status in FIG. 36 will update the status of the associated task box.

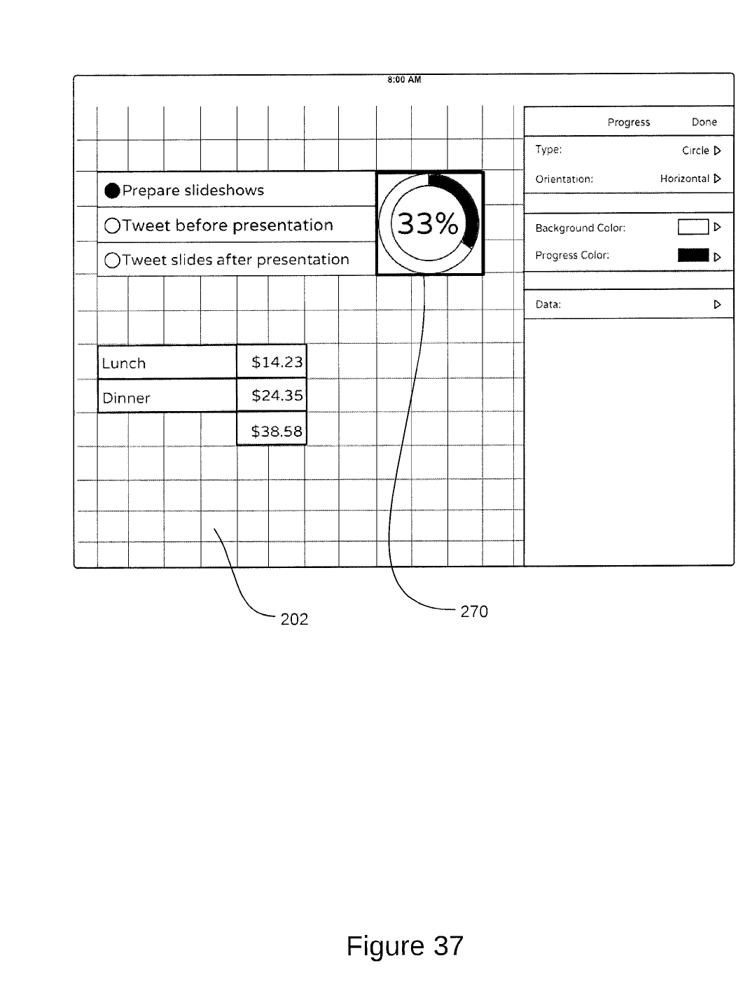

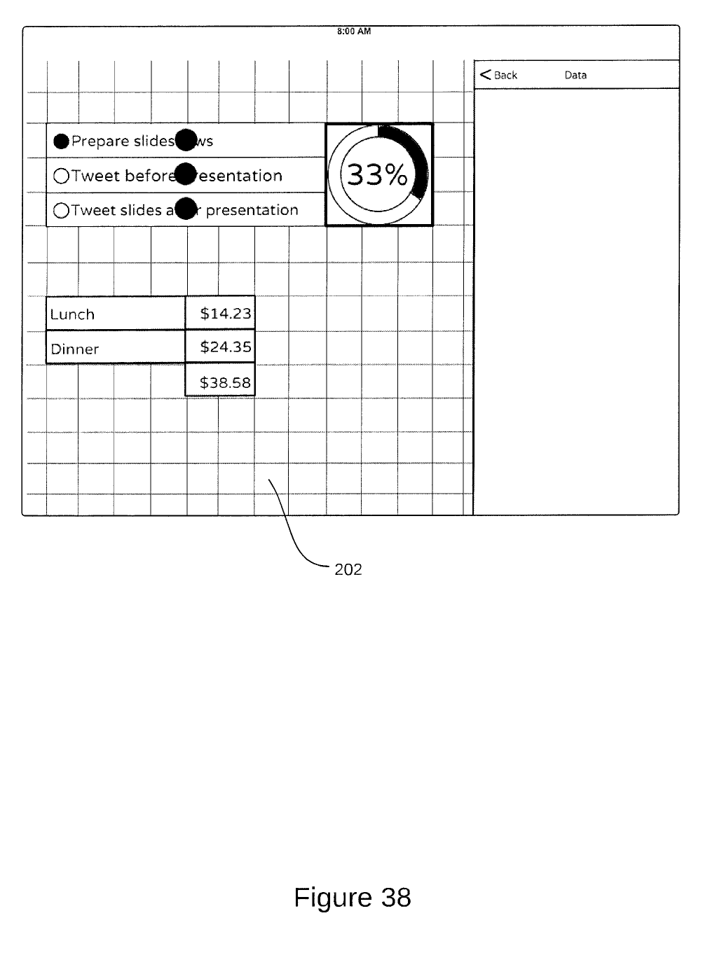

FIG. 37 shows the addition of a progress box data element 270 adjoining the three task-type data elements. The default behavior of a progress box is to display the percentage of completed tasks based on all adjacent boxes to the progress box and adjacent boxes. When editing a progress box the property sheet 238 has a row labeled “Data” as shown in FIG. 37. Tapping the data row in the property sheet 238 will highlight all data elements that are being used as input to the progress box data element. The three tasks have filled in markers as shown in FIG. 38. Tapping on a marker will toggle the exclusion/inclusion of the task as part of the set of tasks used to calculate the progress percentage as shown in FIG. 38. In certain embodiments, the user is provided with options to include/exclude other data elements within the workspace, even if they are not in an associative spatial relationship, by the user's manual selection of those data elements.

In accordance with the methodology discussed with reference to FIG. 15, it may be determined that task-type data elements 260, 262 and 264 are associated (because they are arranged in contiguous fashion within the workspace). These contiguous data elements form a task presentation 208. Further, the engine may determine that progress box 270 is also associated, and the data element interaction engine 156 may determine that information exchange is required and that the associate progress is to be determined and displayed in the progress box data element. Accordingly, when data element 270 is moved into contiguous relationship with data elements 260, 262 and 264, the data element interaction engine automatedly determines and displays the progress result in data element 270, as shown in FIG. 32. Thus, a system-created progress visualization 210 of the data in task presentation 208 is provided.

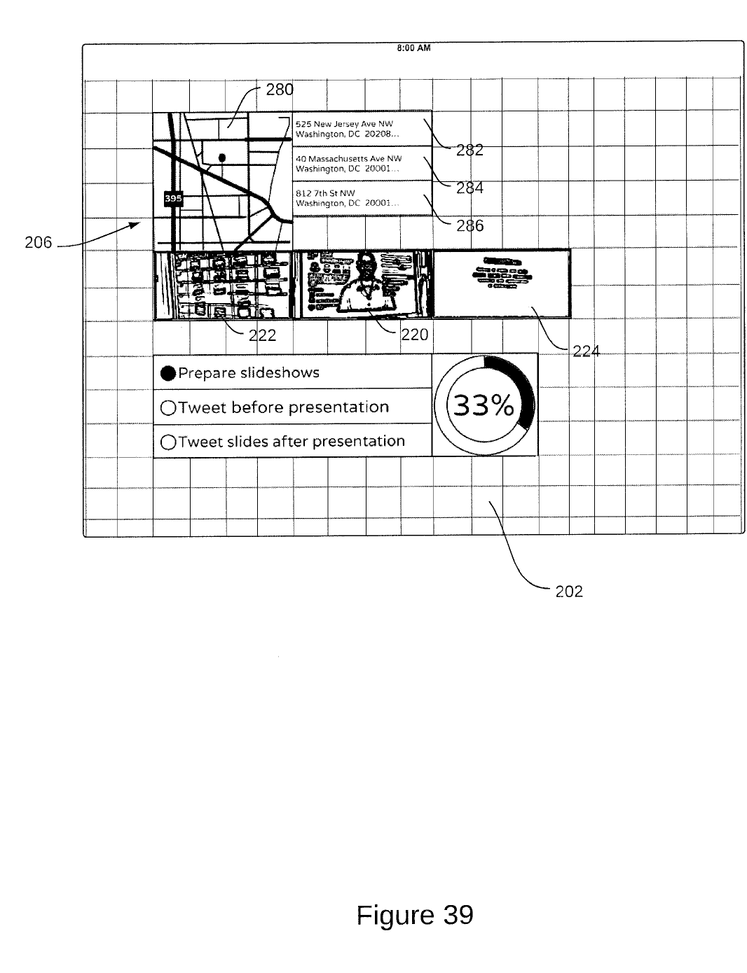

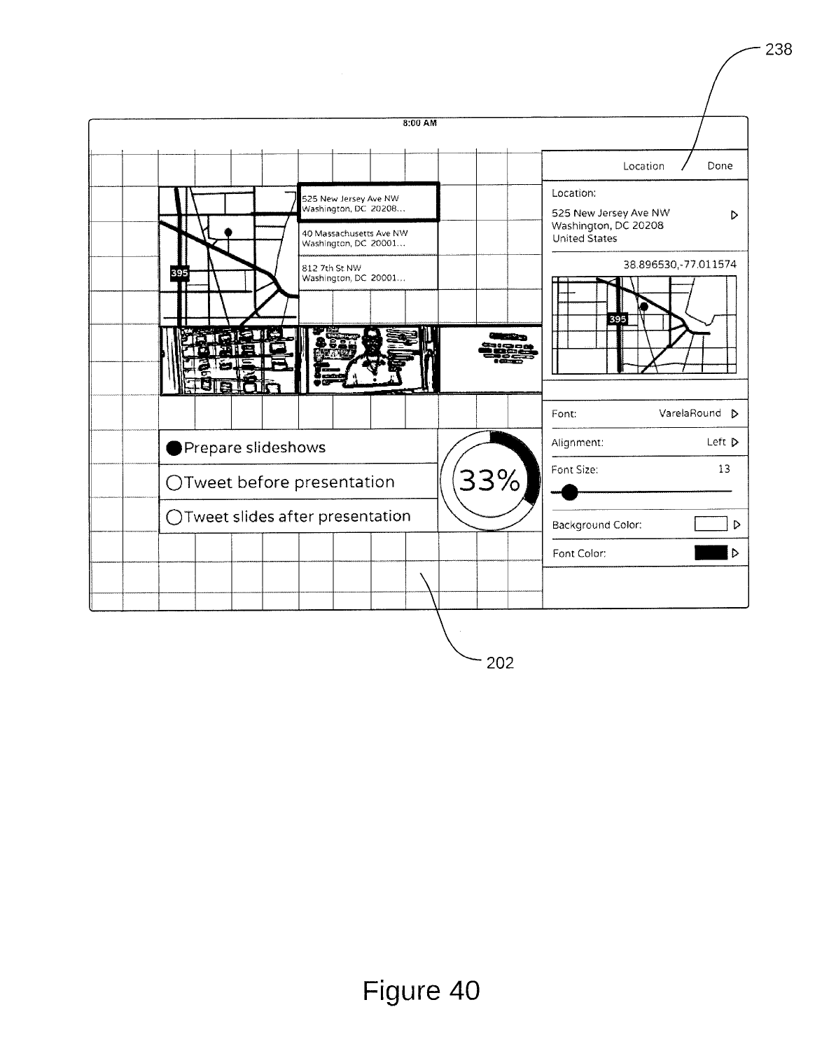

FIGS. 6 and 39 further display an associated exemplary map visualization 206. A map-type data element can show content from other associated data elements that contain geolocation information. For example, in FIG. 39 the map data element 280 is adjacent to three associated location-type data elements 282, 284, 286 and three associated image-type data elements 220, 222, 224. These data elements can be created and positioned/associated in similar fashion. When editing a location-type data element, the latitude and longitude information associated with the address is viewable in the property sheet 238 as shown in FIG. 40. The location-type data element may receive text input from a user in the form of a street address, town, state and zip code, as is conventional. The corresponding latitude and longitude information may be automated retrieved (in accordance with instructions associated with the location-type data element). This information may be retrieved e.g., via the data element interaction engine 156, via a communications network from the external content system 90, e.g., using an appropriate API providing for such information exchange.

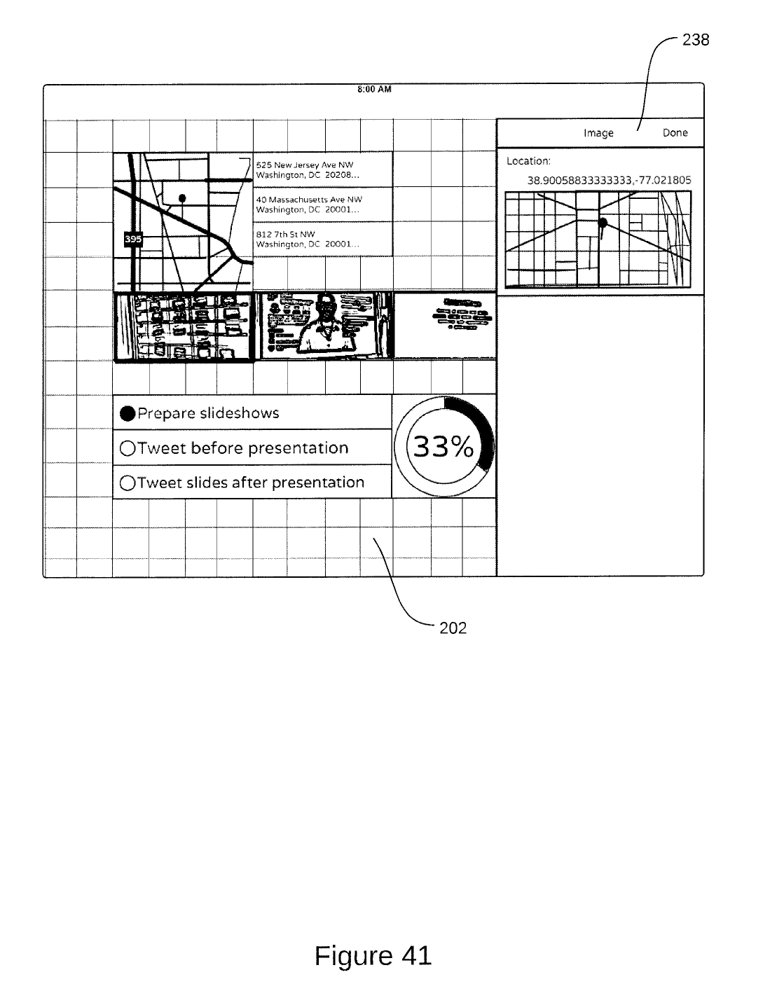

When editing an image-type data element, the latitude and longitude information associated with the image is viewable in the property sheet 238, as shown in FIG. 41. This information may be retrieved from metadata associated with a photographic image file.

In accordance with the methodology discussed with reference to FIG. 15, it may be determined these map-, image- and location-type data elements are associated (because they are arranged in contiguous fashion within the workspace). In accordance with the corresponding data element definitions 162, the data element interaction engine 156 may determine that information retrieval is required to obtain a map of the relevant region, and that information exchange is required to identify pin locations for placement on the map, such that pins can be placed on the map corresponding to the locations in the image-type and location-type data element data. Accordingly, when map data element 280 is moved into contiguous relationship with the other data elements exchanges and retrieves information and displays the resulting map and pins in map data element 280, as shown in FIG. 39. This is performed automatically upon the user's movement of the data element 280 into contiguous relationship with the associated data elements within the workspace 202. The map is a system-created visualization of the data presented in a presentation of the corresponding location and image data elements.

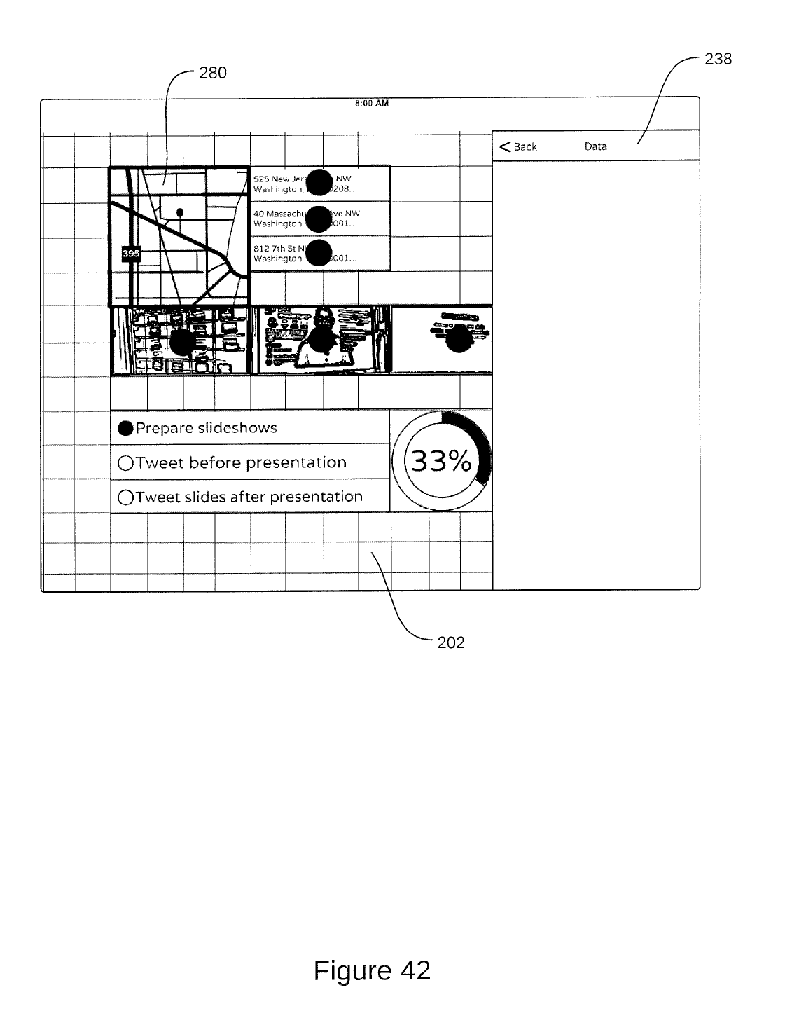

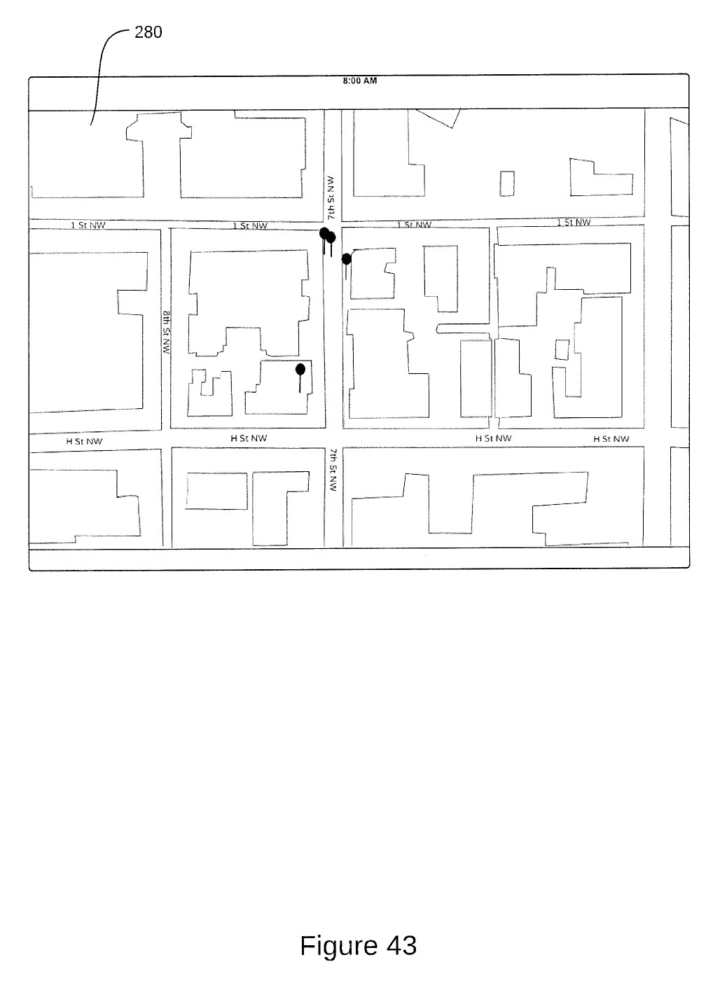

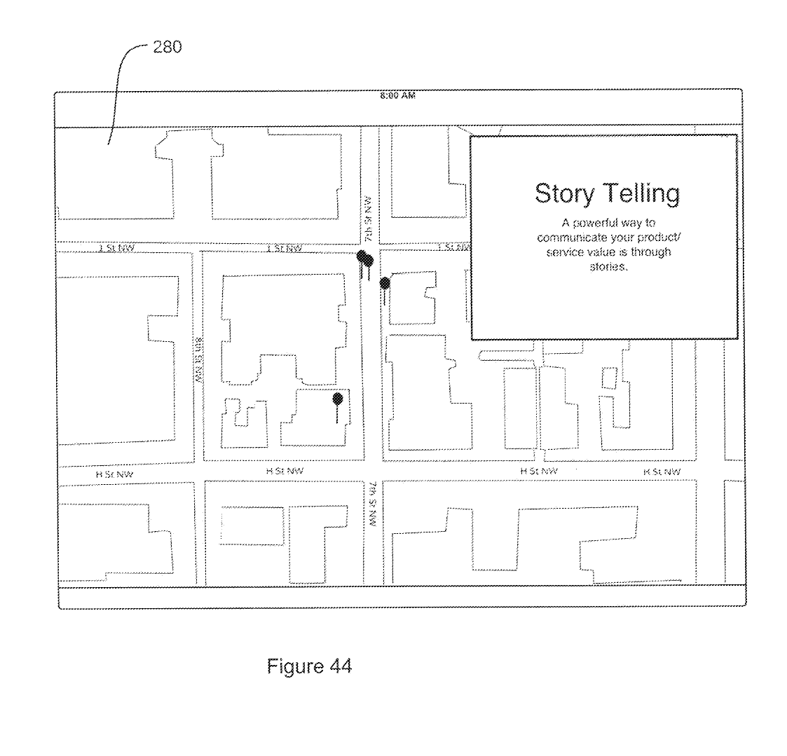

When editing a map-type data element and viewing the data property in the property sheet all of the boxes with a geolocation that will be displayed in the map will have a filled marker, as shown in FIG. 42. Tapping the map box 280 will display of a full screen map, as shown in FIG. 43. Tapping on a pin that represents an image-type data element will display the corresponding image as an overlay on the map as shown in FIG. 44.

It should be appreciated that the touchscreen interface referenced above was merely illustrative, and non-limiting. The teachings of the present invention may be implemented in other systems having other input devices and/or lacking a touchscreen device, while still providing the functionality described herein.

Further, the illustrative example involves selecting a data element type from a menu. However, in alternative embodiments, the a generic data element may be used initially to receive user input, and then the system may process/recognize the input, recognize the corresponding data type, and automatedly select a correspond data element type and/or data element appropriate rules/instructions/logic, etc.

Additionally, computer readable media storing computer readable code for carrying out the method steps identified above is provided. The computer readable media stores code for carrying out subprocesses for carrying out the methods described herein.

A computer program product recorded on a computer readable medium for carrying out the method steps identified herein is provided. The computer program product comprises computer readable means for carrying out the methods described above.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A computer-implemented method for information presentation and visualization via a computerized presentation system including at least one processor and a memory operatively coupled to the memory and storing instructions executable by the processor, the method comprising:
storing in memory a data store of predefined data element types, each data element type being configured to receive user input, and to interact with any associated data elements according to predefined instructions stored within the system;
displaying via a display device a graphical user interface displaying a workspace and permitting a user to:
create a plurality of data elements by permitting a user to:
select a data element type from a menu of predefined data element types;
create a data element having the data element type; and
provide user input in association with the data element; and
arrange created data elements within the workspace to selectively indicate association among multiple data elements by selectively arranging data elements to be associated in a predefined associative spatial relationship stored defined by the presentation system;
identifying associated data elements;
exchanging information associated with at least one of the associated data elements, in accordance with the predefined instructions; and
displaying, via the graphical user interface, a visualization of information as a function of the exchanged information;
whereby said presentation system provides a graphical user interface with user-manipulable data elements that cause the system to create and/or display information as a function of a user-created spatial arrangement of predefined, user-configured, data elements.

2. The method of claim 1, wherein at least one of said plurality of data elements is a text-type data element configured to receive text and display parameters.

3. The method of claim 1, wherein at least one of said plurality of data elements is an image-type data element configured to receive an image file and display parameters.

4. The method of claim 1, wherein at least one of said plurality of data elements is a number-type data element configured to receive numbers, formulas, and parameters.

5. The method of claim 1, wherein said presentation system comprises a user input engine for receiving input from a user, the method comprising:
in response to the presentation system's receipt of information corresponding to:
a user's creation of a plurality of particular data elements having respective data element types and respective associated user input; and
arrangement of the particular data elements within the workspace;
determining whether the particular data elements are arranged within the workspace in a predefined associative spatial relationship stored defined by the presentation system to selectively indicate association among them; and
if the particular data elements are determined to be arranged to selectively indicate association among them,
exchanging associated information among the particular data elements in accordance with the predefined instructions; and
displaying, via the graphical user interface, a visualization of information as a function of the exchanged information.

6. The method of claim 5, wherein said presentation system stores in its memory predefined instructions to perform a mathematical operation on numbers contained in number-type data elements.

7. The method of claim 5, wherein said determining comprises determining whether data elements displayed within the workspace are positioned adjacent one another within the workspace.

8. The method of claim 5, wherein said determining comprises determining whether data elements displayed within the workspace are positioned with their respective edges in abutting relationship to one another.

9. The method of claim 5, wherein displaying the visualization of information comprises display of a sum of numbers contained in number-type data elements.

10. The method of claim 5, wherein displaying the visualization of information comprises display of a chart of numbers contained in number-type data elements.

11. A presentation system comprising:
a processor;
a memory operatively connected to the processor, said memory storing executable instructions that, when executed by the processor, causes the presentation system to perform a method for information presentation and visualization, the method comprising:
storing a data store of predefined data element types, each data element type being configured to receive user input, and to interact with any associated data elements according to predefined instructions stored within the system;
displaying via a display device a graphical user interface displaying a workspace and permitting a user to:
create a plurality of data elements by permitting a user to:
select a data element type from a menu of predefined data element types;
create a data element having the data element type; and
provide user input in association with the data element; and
arrange created data elements within the workspace to selectively indicate association among multiple data elements by selectively arranging data elements to be associated in a predefined associative spatial relationship defined by the presentation system;
identifying associated data elements;
exchanging information associated with at least one of the associated data elements, in accordance with the predefined instructions; and
displaying, via the graphical user interface a visualization of information as a function of the exchanged information.

12. The presentation system of claim 11, further comprising a presentation engine comprising a workspace engine, a user input engine, a data element interaction engine, and an output engine.

13. The presentation system of claim 12, wherein said presentation engine comprises a data store storing data element definitions, data element configuration input provided by a user, and data element content retrieved via a communications network from an external content provider system.

14. The presentation system of claim 11, further comprising a user input engine for receiving input from a user, the method comprising:
in response to the presentation system's receipt of information corresponding to:
a user's creation of a plurality of particular data elements having respective data element types and respective associated user input; and
arrangement of the particular data elements within the workspace;
determining whether the particular data elements are arranged within the workspace in a predefined associative spatial relationship stored defined by the presentation system to selectively indicate association among them; and
if the particular data elements are determined to be arranged to selectively indicate association among them,
exchanging associated information among the particular data elements in accordance with the predefined instructions; and
displaying, via the graphical user interface, a visualization of information as a function of the exchanged information.

15. The presentation system of claim 14, wherein said presentation system stores in its memory predefined instructions to perform a mathematical operation on numbers contained in number-type data elements.

16. The presentation system of claim 14, wherein said determining comprises determining whether data elements displayed within the workspace are positioned adjacent one another within the workspace.

17. The presentation system of claim 14, wherein said determining comprises determining whether data elements displayed within the workspace are positioned with their respective edges in abutting relationship to one another.

18. A computer program product form implementing a method for information presentation and visualization, the computer program product comprising a non-transitory computer-readable medium storing executable instructions that, when executed by a processor, cause a presentation engine of a computerized system to perform a method for information presentation and visualization, the method comprising:
storing a data store of predefined data element types, each data element type being configured to receive user input, and to interact with any associated data elements according to predefined instructions stored within the system;
displaying via a display device a graphical user interface displaying a workspace and permitting a user to:
create a plurality of data elements by permitting a user to:
select a data element type from a menu of predefined data element types;
create a data element having the data element type; and
provide user input in association with the data element; and
arrange created data elements within the workspace to selectively indicate association among multiple data elements by selectively arranging data elements to be associated in a predefined associative spatial relationship defined by the presentation system;
identifying associated data elements;
exchanging information associated with at least one of the associated data elements, in accordance with the predefined instructions; and
displaying, via the graphical user interface a visualization of information as a function of the exchanged information.

19. The computer program product of claim 18, said stored instructions further comprising executable instructions that, when executed by a processor, cause a presentation engine of a computerized system to:
determine whether the particular data elements are arranged within the workspace in a predefined associative spatial relationship stored defined by the presentation system to selectively indicate association among them; and
if the particular data elements are determined to be arranged to selectively indicate association among them,
exchange associated information among the particular data elements in accordance with the predefined instructions; and
display, via the graphical user interface, a visualization of information as a function of the exchanged information.

20. The computer program product of claim 19, said stored instructions further comprising executable instructions that, when executed by a processor, cause a presentation engine of a computerized system to:
perform a mathematical operation on numbers contained in number-type data elements.

21. The computer program product of claim 19, said stored instructions further comprising executable instructions that, when executed by a processor, cause a presentation engine of a computerized system to:
determine whether data elements displayed within the workspace are positioned adjacent one another within the workspace.

22. The computer program product of claim 19, said stored instructions further comprising executable instructions that, when executed by a processor, cause a presentation engine of a computerized system to:
determine whether data elements displayed within the workspace are positioned with their respective edges in abutting relationship to one another.
